(19) United States
(12) Patent Application Publication
(10) Pub. No.: US 2025/0139178 A1
(43) Pub. Date: May 1, 2025

(54) METHODS, SYSTEMS, AND APPARATUSES FOR RECOMMENDING CONTENT

(71) Applicant: Comcast Cable Communications, LLC, Philadelphia, PA (US)

(72) Inventors: Kevin Colflesh, Philadelphia, PA (US); Thomas Priore, Philadelphia, PA (US)

(21) Appl. No.: 18/385,957

(22) Filed: Nov. 1, 2023

(51) Int. Cl. G06F 16/9535; G06F 16/9537; G06F 16/9538; H04L 67/306; H04W 4/029

(52) U.S. Cl. CPC G06F 16/9535; G06F 16/9537; G06F 16/9538; H04L 67/306; H04W 4/029

(57) ABSTRACT

Systems, methods, and apparatuses may be provided for recommending content. Multiple mobile devices may be detected within a premises. A profile associated with the multiple mobile devices may be determined. The profile may be evaluated to determine content to recommend. The content recommendations may be caused to be displayed at a display device within the premises.

### BACKGROUND

Providing personalized or directed content (e.g., content items, previews, advertising) to a person or group of people within a location (e.g., a premises, residence, or business) has typically required a user to log in to a device, such as a mobile device, and fill out information identifying themselves and directly associating themselves with the device. However, users may not feel compelled to identify themselves when watching content items, such as television content, on a display device, such as a television. For example, users may not want to take the additional time to indicate that they are watching the content items. Furthermore, when multiple users are watching the content items, the amount of time required to “log-in” each user to indicate they are watching the content items may be significant and interrupt the actual viewing of the content item.

### SUMMARY

It is to be understood that both the following general description and the following detailed description are exemplary and explanatory only and are not restrictive. Methods, systems, and apparatuses systems for analyzing content are described.

Systems, methods, and apparatuses may be provided for recommending content. For example, a request for content items or for a recommendation of content items may be received for output on a display. The location of a computing device for outputting content from which the request was received may be determined. Based on the location, one or more access points may determine one or more mobile devices within the location or within a predetermined distance of the location. A stored profile associated with the one or more mobile devices may be determined. For example, when multiple mobile devices are determined to be within the location or within the predetermined distance of the location, a profile may be identified that is based on or associated with (e.g., includes identifiers associated with) each of the mobile devices. As such, when multiple users, each with a mobile device, are inferred, based on the location of the mobile devices associated with the multiple users, to be together watching the output on the display associated with the computing device for outputting content, a single profile associated with those multiple users, and accordingly the multiple mobile devices, may be determined or created. Information may be obtained from the determined profile. For example, the information may include a viewing history of content items, interests of the user(s) associated with the profile, demographic information for the user(s) associated with the profile, and the like. Recommendations for content items, advertisements, and/or other content may be provided for display on the display device based on the information determined from the profile.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for recommending content;

FIG. 2 shows an example communication diagram for recommending content;

FIG. 3 shows an example communication diagram for modifying a setting of a device;

FIG. 4 shows an example diagram of a premises;

FIG. 5 shows a flowchart of an example method;

FIG. 6 shows a flowchart of an example method;

FIG. 7 shows a flowchart of an example method;

FIG. 8 shows a flowchart of an example method;

FIG. 9 shows a flowchart of an example method;

FIG. 10 shows a flowchart of an example method; and

FIG. 11 shows a block diagram of an example system and computing device for recommending content.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content,” as the phrase is used herein, may also be referred to as “content items,” “content data,” “content information,” “content asset,” or simply “data” or “information”. Content may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to Moving Pictures Experts Group (MPEG), MPEG2, MPEG4 UHD, HDR, 4k, Adobe® Flash® Video (.FLV) format or some other video file format whether such format is presently known or developed in the future. The content described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (dai), Adobe® Photoshop® (.PSD) format or some other format for electronically storing text, graphics and/or other information whether such format is presently known or developed in the future. Content may be any combination of the above-described formats.

This detailed description may refer to a given entity performing some action. It should be understood that this language may in some cases mean that a system (e.g., a computer) owned and/or controlled by the given entity is actually performing the action.

Methods, systems and apparatuses are described herein for the recommending content and for adjusting settings of other devices (e.g., Internet of Things (IoT) devices, thermostats, luminaires, smart speakers, switches, electrical receptacles, fans, security systems, and the like). The methods, systems, and apparatuses described herein may be employed to determine mobile devices (e.g., a mobile phone, a smartphone, a smartwatch, a tablet computer, a laptop computer, smart glasses, a wearable smart device, transient device, personal device, portable device, non-stationary devices, or the like) within a premises (e.g., residence/business) and/or near (e.g., proximate to) a computing device for outputting content, such as a media device, display, computer, or the like. The mobile devices proximate to the computing device for outputting content may be used to infer the person or people that are proximate to a device displaying the content. Similarly, the mobile devices within a premises may be used to infer the person or people within the premises or within a particular room having or proximate to the computing device for outputting content or within a particular distance from the computing device for outputting content. The methods, systems, and apparatuses described herein may be further employed to determine a profile for the person or a combined profile (e.g., a single profile for multiple people associated with multiple devices) for the people proximate to the display device and/or within the premises. The methods, systems, and apparatuses described herein may be further employed to recommend content based on information within the profile and/or adjust device settings based on information within the profile. For example, a profile covering three mobile devices associated with three different people may be based on historical information associated with those three people together, rather than individually. For example, information associated with content items watched, partially watched, saved playlists, items interest has been shown in, query histories, etc. when the three mobile devices are determined to be proximate to the computing device for outputting content (and inferring the three people are watching the content item on a display device comprising or associated with the computing device for outputting content) may be stored and evaluated each time the three devices, and optionally only those three devices, are determined to be proximate to the computing device for outputting content. Furthermore, changes in temperature settings of the premises, what lights are turned on/turned off and the light level, audio level, fan settings, security system settings, or other device settings may also be determined and stored in the profile covering the three mobile devices when the three mobile devices, and optionally only those three mobile devices, are determined to be proximate to the computing device for outputting content and/or within a particular room or portion of the premises.

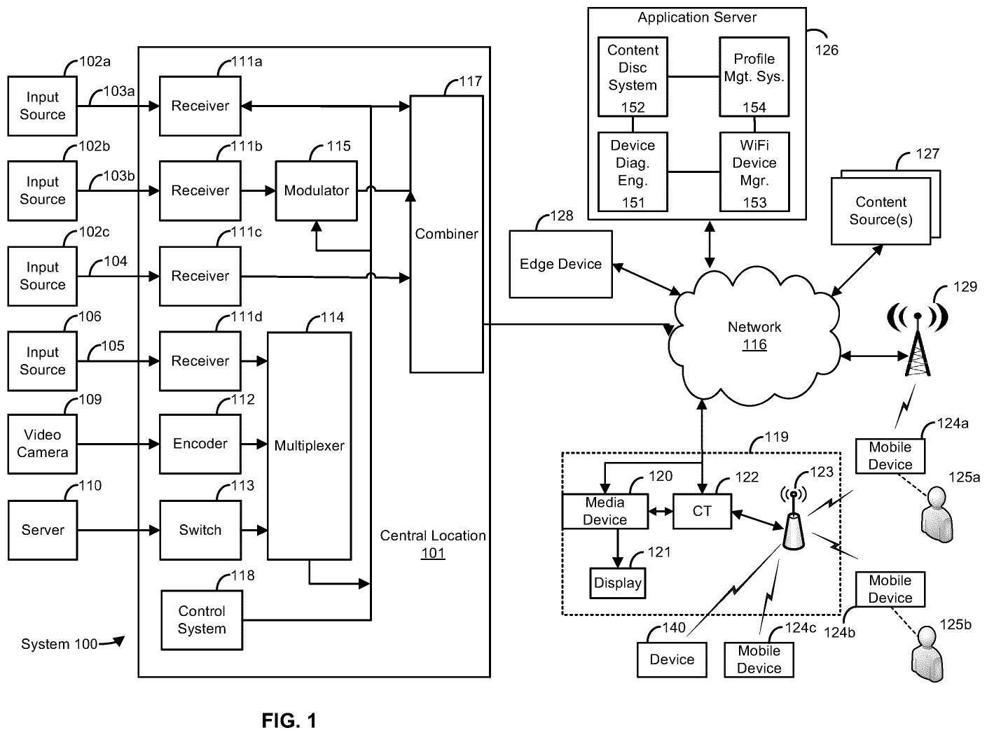

FIG. 1 shows a system 100 for recommending content and/or modifying device settings. Those skilled in the art will appreciate that digital equipment and/or analog equipment may be employed. One skilled in the art will appreciate that provided herein is a functional description and that the respective functions may be performed by software, hardware, or a combination of software and hardware.

The system 100 may have a central location 101 (e.g., a headend), which may receive content (e.g., a plurality of content items) from multiple sources. The central location 101 may combine the content from the various sources and may distribute the content to user (e.g., subscriber) locations (e.g., user location 119) via a network 116.

The central location 101 may receive content from a variety of sources. For example, the central location 101 may receive content from sources 102a-c. The content may be sent (e.g., transmitted) from the sources 102a-c to the central location 101 via a variety of transmission paths, such as wireless paths (e.g. satellite paths 103a, 103b) and terrestrial path 104. The central location 101 may also receive content from an input source 106 via a direct line 105 (e.g., one or more communication links and/or one or more communication paths). Other input sources may comprise capture devices, such as a video camera 109, a server 110, and/or the like. The content provided by the content sources may comprise a single content item (e.g., a movie, a television show, an advertisement, a sporting event, a news program, etc.), a portion of a content item (e.g., one or a plurality of content fragments), a content stream, a multiplex that includes several content items, and/or the like.

The central location 101 may comprise one or a plurality of receivers 111a-d. For example, the receivers 111a-d may be associated with one or more corresponding input sources 102a-c, 106. The central location 101 may comprise one or more encoders 112, one or more switches 113, one or more multiplexers, and/or the like. The one or more encoders 112 may compress, encrypt, transform, and/or otherwise encode content. The one or more encoders 112 may encode content (e.g., content items and/or content fragments) based on one or more compression standards, such as MPEG. The one or more encoders 112 may receive content from the video camera 109 and/or other source 102a-c, 106 and apply one or more encoding algorithms to the received content. The one or more switches 113 may provide access to a server 110. For example, the server 110 may be a Pay-Per-View server, a data server, an internet router, a network system, a phone system, and/or the like. Some signals, for example, may require additional processing, prior to being modulated. The additional processing may include signal multiplexing. For example, the signal multiplexing may be performed by one or more multiplexers 114.

The central location 101 may comprise one or more modulators 115. For example, the one or more modulators may be configured for interfacing with the network 116. For example, the one or more modulators 115 may receive content from the receiver 111, the encoder 112, the multiplexer 114, and/or the like. The one or more modulators 115 may convert the received content (e.g., the one or more content items) into a modulated output signal suitable for transmission over the network 116. The one or more modulators 115 may map portions of the content to data bits expressed as signals (e.g., sinusoidal signals) at corresponding subcarrier frequencies of a data symbol. The output signals from the modulators 115 may be combined, using equipment such as a combiner 117, for input into the network 116.

For example, the network 116 may be a content delivery network, a content access network, and/or the like. The network 116 may be configured to provide content from a variety of sources using a variety of network paths, protocols, devices, and/or the like. The network 116 (e.g., the content delivery network and/or content access network) may be managed (e.g., deployed, serviced) by a content provider (e.g., the central location 101), a service provider, and/or the like.

The central location 101 may comprise a control system 118. The control system 118 may permit a system operator to control and monitor the functions and performance of the system 100. For example, the control system 118 may interface, monitor, and/or control a variety of functions, including, but not limited to, the channel lineup for a television system, billing for each person or user or user device, conditional access for content distributed to users, and the like. The control system 118 may provide input to the one or more modulators 115 for setting operating parameters, such as system specific MPEG table packet organization or conditional access information. For example, the control system 118 may be located at central location 101 or at a remote location alone or a part of another computing device.

The network 116 may distribute content from the central location 101 to one or more user locations, such as the user location 119. For example, the network 116 may be an optical fiber network, a coaxial cable network, a hybrid fiber-coaxial network, a wireless network, a satellite system, a direct broadcast system, or any combination thereof.

A multitude of users (e.g., via a plurality of user devices, such as the mobile devices 124a-c, the display device 121, and/or the device 140) may be connected to the network 116. For example, the user location 119 may include a computing device for outputting content. For example, the computing device for outputting content may comprise a media device 120. For example, the media device 120 may comprise a set-top box, a digital streaming device, a gaming device, a media storage device, a digital recording device, a computing device, a mobile computing device (e.g., a laptop, a smartphone, a tablet, etc.), a display device 121 a combination thereof, and/or the like. The media device 120 may demodulate and/or decode, if needed, the signals for displaying or causing display of content on the display device 121. For example, the display device 121 may be a television (TV), a projector system, or a computer monitor. For example, the media device 120 may comprise a demodulator, decoder, frequency tuner, set-top-box and/or the like. In certain examples, the functions of the media device 120 may be embedded into the display device 121. The media device 120 may be directly connected to the network 116 (e.g., for communications via in-band and/or out-of-band signals of a content delivery network) and/or connected to the network 116 via a communication terminal 122 (e.g., for communications via a packet switched network). For example, the media device 120 may implement one or more applications, such as content viewers, social media applications, news applications, gaming applications, content stores, electronic program guides, on-demand guides, streaming services, and/or the like. Those skilled in the art will appreciate that the signal may be demodulated and/or decoded in other examples in a variety of other equipment, including, but not limited to, the communication terminal 122, the display device 121, a computer, a TV, a monitor, or a satellite dish.

The communication terminal 122 may be located at the user location 119. The communication terminal 122 may be configured to communicate with the network 116. For example, the communication terminal 122 may be a modem (e.g., cable modem), a router, a gateway, a switch, a network terminal (e.g., optical network unit), and/or the like. The communication terminal 122 may be configured for communication with the network 116 via a variety of protocols, such as an internet protocol, a transmission control protocol, a file transfer protocol, a session initiation protocol, a voice over internet protocol (VOIP), and/or the like. For example, the communication terminal 122, for a cable network, may be configured to provide network access via a variety of communication protocols and standards, such as Data Over Cable Service Interface Specification (DOCSIS).

For example, the user location 119 may include an access point 123 (e.g., a wireless access point). The access point 123 may be configured to provide one or more wireless networks in all or at least a portion of the user location 119. For example, the user location 119 may be a premises (e.g., a house, apartment, condo, townhouse, a business location, store, bar, or the like) or portion of the premises. For example, the user location 119 may have multiple access points 123 positioned around the premises. The access point 123 may be configured to provide access to the network 116 to devices configured with a compatible wireless radio, such as a mobile devices 124a-c, the media device 120, the display device 121, the device 140, or other computing devices (e.g., laptops, IoT devices, sensor devices, security devices, etc.). The access point 123 may provide a user-managed network (e.g., local area network (LAN)), a service provider managed network (e.g., public network for users of the service provider), and/or the like. It should be noted that in some configurations, some or all of the access point 123, the communication terminal 122, the media device 120, and the display device 121 may be implemented as a single device.

The user location 119 is not necessarily fixed. For example, a first person 125a may receive content from the network 116 on the first mobile device 124a. The first mobile device 124a (and any one or more of the other mobile devices 124b-c) may be a laptop computer, a tablet computer, a personal data assistant (PDA), a mobile phone, a smart phone, a smart watch, smart glasses, a wearable smart device, a combination thereof, and/or the like. The first mobile device 124a may communicate with a variety of access points (e.g., at different times and locations or simultaneously if within range of multiple access points) either within the premises or after leaving the premises. For example, the first mobile device 124a may communicate with a second access point 129. The second access point 129 may be a cell tower, a wireless hotspot, another mobile device, and/or other remote access point. For example, the second access point 129 may be located within a second premises different from the first premises. For example, the first person 125a may be a visitor to the user location 119 and may live at the second premises having the second access point 129, which may be near or remote from the user location 119. In another example, the first person 125a may reside at the user location 119 and may be a visitor to the premises having the second access point 129. For example, the second access point 129 may be within range of the user location 119 or remote from the user location 119. The second access point 129 may be located along a travel route, within a premises, or other useful locations (e.g., travel stop, city center, park, etc.).

The system 100 may include one or more devices 140. The one or more devices 140 may be at or within the user location 119 (e.g., within the premises identified by the user location 119). The one or more devices 140 may be communicably coupled to the access point 123 and one or more of the mobile devices 124a-c. For example, the one or more devices 140 may communicate with the access point 123 and/or one or more of the mobile devices 124a-c via one or more wireless communication techniques, such as one or more of Wi-Fi, Bluetooth, Bluetooth Low-Energy (BLE), Zigbee, Z-Wave, GLOWPAN, WiFi Direct, near field communication (NFC). Long Range (LoRa), LoRaWAN, or the like. The device 140 may be any device capable of having one or more settings adjusted. The settings may include turning on the device, turning off the device, an operation level of the device, a timer for the device, or the like. Examples of the device 140 may include, but are not limited to Internet of Things (IoT) devices, thermostats, luminaires, smart speakers, switches, electrical receptacles, fans, security systems, and the like.

The system 100 may have an application server 126. The application server 126 may provide services related to applications. The application server 126 may be located in the cloud. For example, the application server 126 may be part of the central location 101 or another computer device, server, or the like. The application server 126 may include a device diagnostics engine 151. The device diagnostics engine 151 may be configured to communicate with one or more of the access point 123, the second access point 129, the media device 120 or the display device 121 via the network 116 or another network. The device diagnostics engine 151 may send a request to the access point 123, 129, media device 120, or display device 121 for an indication of the user devices (e.g., mobile devices 124a-c) connected to the access point 123, 129, media device 120, or display device 121, and the signal level data (e.g., signal-to-noise ratio (SNR), received signal strength indicator (RSSI), which antenna of the access point receives the data from the particular mobile device 124a-c, and the like) for each particular mobile device 124a-c. For example, the indication of the mobile device may be an identifier of the mobile device, such as the MAC address of the mobile device, another unique identifier of the mobile device, a user name associated with the mobile device, or an account identifier associated with the mobile device. For example, the device diagnostics engine 151 may receive indications of other devices within the user location 119 capable of wireless communication. For example, these other devices may be stationary devices (e.g., devices that are not generally moved around the user location 119 or do not come and go from the user location 119). Stationary devices may include the display device 121, the media device 120 one or more devices 140 (e.g., a thermostat, luminaire or light source, smart speakers, switches, electrical receptacles, fans, smart appliance, security systems, etc.). For example, the determination of whether the device is a mobile device or stationary device may be based on how often the device has moved over a period of time (e.g., a day, a week, a month). For example, devices that have not moved for a month may be determined to be stationary wireless communication devices while device that move daily or weekly may be determined to be mobile devices. The device diagnostics engine 151 may receive the indication of the one or more mobile devices 124a-c for which signals are being received by the access point 123, 129, media device 120, or display device 121, and the signal level data for each mobile device at that particular access point 123, 129, media device 120, or display device 121. The device diagnostics engine 151 may associate the mobile device identifier and the signal level data with the particular device receiving the signal (e.g., the access point 123, 129, media device 120, or display device 121) and store the data for subsequent use.

The application server 126 may include a Wi-Fi device manager 153. The Wi-Fi device manager 153 may be in communication with the device diagnostics engine 151. The Wi-Fi device manager 153 may be able to evaluate the identifier for each device mobile device received by the device diagnostics engine 151 and determine if the particular wireless communication device is a mobile device or a stationary device. For example, the Wi-Fi device manager 153 may determine if a particular device is a mobile device or a stationary device based on how often the device is moved from a location. For example, the determination of whether the device is a mobile device or stationary device may be based on how often the device has moved over a period of time (e.g., a day, a week, a month). For example, devices that have not moved for a month may be determined to be stationary wireless communication devices while device that move daily or weekly may be determined to be mobile devices.

A stationary device's association with a particular user may not be useful in determining whether the user is in the location of the particular device, since it is not typically transported or carried by the user when they move from place to place. On the other hand a mobile device, such as a mobile phone, smartwatch, or tablet device may be more likely to be carried by the user and move from place-to-place with the user and thus, may be used to determine the location of the user.

For example, the Wi-Fi device manager 153 may also determine mobile devices that are not typically associated with the user location (e.g., a visitor mobile device). For example, when friends of the owner of the user location 119 visit, those friends may bring along their mobile devices. The Wi-Fi device manager 153 may determine that the identifiers or indications of those particular mobile devices are not associated with the user location 119 or are typically associated with one or more other user locations (e.g., another residence) based on historical location data for those particular mobile devices.

The application server 126 may include a profile management system 154. For example, the profile management system 154 may be configured to store and provide user profiles for a plurality of users. For example, the profile may be generated based on data received from any one or more of the display device 121, media device 123, mobile devices 124a-c, or devices 140. For example, the data may be received via the network 116 or another network and via the access point 123 and/or communication terminal 122. For example, each user profile may include any one or more of a one or more user names, one or more user identifiers (e.g., an account ID, phone number, address, a unique identifier), one or more mobile devices associated with the one or more user names (e.g., belonging to a particular user), user demographics (e.g., age, sex, race, national origin), viewing history for the one or more users, device settings for one or more devices (e.g., Internet of Things (IoT) devices, thermostats, luminaires, smart speakers, switches, electrical receptacles, fans, smart appliances, security systems, etc.) and the like. For example, a profile may be of a single user (e.g., user 125a) or a profile for multiple users (e.g., a profile for user 125a and user 125b, a profile for three users together, a profile for four users together, etc.).

For example, in situations when user 125a and user 125b are together, the system 100 may monitor and store viewing history for content searched and viewed at a display device 121 where it is believed, based on the location of mobile devices 124a, 124b associated with each user 125a, 125b, that both the user 125a and user 125b are viewing or listening to content. The profile management system 154 may create or determine a profile for the combined group of user 125a and user 125b and may store the user names, user identifiers, identifiers of mobile devices associated with each or user 125a and user 125b, the viewing history when both user 125a and user 125b are watching content on a display device 121, user demographics for each user 125a, 125b, and the like. In situations where a profile for the combined group of users 125a, 125b was previously created, the profile management system may determine the profile associated with or that includes the combined group of users 125a, 125b and monitor and store the viewing history for the content searched and viewed at the display device 121. The combined profile for users 125a and 125b may be a separate profile from the individual profiles for each of users 125a and 125b. In certain examples, some initial information, such as viewing history for the combined profile for users 125a and 125b may be retrieved from the individual profiles for user 125a and/or user 125b. For example, the profile for the combination of users 125a, 125b may be separate and distinct from the individual profile for user 125a and the individual profile for user 125b. Similarly, profiles can be generated and updated for other groups of users (e.g., two users, three users, four users, any number of users together, etc.). The groups of users may be users that reside at the location of the display device being watched, users that do not reside at the location of the display device being watched (e.g., a visitor to a residence or customer to a business) or any combination thereof. These profiles may be stored in the profile management system 154 and may be accessed when that particular group of users are determined to be together again, based on the indication of the location of mobile devices associated with each user in the group, and believed to be watching content on the display device. Each time a group of users is together, the system 100 may collect viewing history for the content items viewed by the group of users, search history for searches for content items requested while the group is viewing the content, setting levels for one or more devices 140 (e.g., within the user location 119 of the display device 121) when the group of users is together, and the like.

The application server 126 may include a content discovery system 152. The content discovery system 152 may be configured to communicate with one or more of the access point 124, the second access point 129, the media device 120 or the display device 121, via the network 116 or another network. The content discovery system 152 may be configured to receive a request from the computing device for outputting content, such as the media device 120 or display device 121. The request may be a request to browse content items that can be viewed, for a recommendation of one or more content items, or to review particular content items. The request may also include signal level data associated with the computing device for outputting content, such as one or more of the media device 120 or the display device 121. The request may be received by the content discovery system 152 via the network 116 or another network. The content discovery system 152 may determine the location associated with the request (e.g., the user location 119). The content discovery system 152 may request and/or receive the mobile devices 124a-c connected to an access point 123, media device 120, or display device 121 at the user location 119 and the signal level data for each mobile device connected at that user location 119 from the device diagnostic engine 151. The content discovery system 152 may request and/or receive and/or determine one or more profiles associated with (e.g., including an identifier of) the one or more mobile devices 124a-c connected at the user location 119. The content discovery system 152 may compare the signal level data received in the request and/or the known location of the computing device for outputting content (e.g., the display device 121 and/or media device 120) to the signal level data for the one or more mobile devices 124a-c connected at the access point(s) 123 at the user location 119 to determine which mobile devices 124a-c are proximate to the computing device for accessing content (and thus likely having an associated user watching the content on the display device 121). For example, the content discovery system 152 may determine which mobile devices 124a-c have an RSSI and/or SNR that is within a predetermined threshold of the RSSI and/or SNR of the requesting device (e.g., the computing device for outputting content, such as the media device 120 or display device 121). For example, the threshold may be a particular value, amount, or percentage from which the RSSI and/or SNR may vary from the RSSI and/or SNR of the requesting device. For example, the content discovery system 152 may also determine which antenna of the access point 123 the signal was received from the requesting device and the mobile devices 124a-c to determine the location of the mobile devices 124a-c with respect to the requesting device. For example, the content discovery system 152 may not consider mobile devices 124a-c, whose signal was received by a different antenna of the access point 123 as that of the requesting device, to be proximate to the requesting device and thus the users associated with those mobile devices are likely not watching the content on the display device 121.

Based on the identifiers (e.g., MAC address) of the mobile devices 124a-c determined to be proximate to the computing device for outputting content (e.g., media device 120 or the display device 121) the content discovery system 152 may determine a profile, from the profile management system 154, that is based on or associated with (e.g., matches) the combination of users associated with particular mobile devices. For example, if mobile devices 124a and 124b are determined to be proximate to the requesting device, the content discovery system 152 will look for a profile that is based on or associated with both the user associated with mobile device 124a and the user associated with mobile device 124b, and no additional devices or users. For example, the content discovery system 152 may look for a profile that has mobile device identifiers that match the mobile device identifiers (e.g., MAC address) for the mobile devices 124a and 124b.

For example, if a profile associated with the combination of mobile device 124a and 124b has not yet been created, then the profile management system 154 may create or determine a new profile for the combination of mobile device 124a and 124b and begin associating data with the profile. For example, if individual profiles have previously been stored for mobile device 124a and mobile device 124b, data such as user names, user identifiers (e.g., an account ID, phone number, address, a unique identifier), mobile devices associated with the particular user name, user demographics (e.g., age, sex, race, national origin), locations (e.g., user location 119) of the user, viewing history or searches for the particular user, device settings for one or more devices associated with the particular user (e.g., in locations where the user has been), and the like. Once a profile is created or determined for the particular combination of mobile devices, subsequent locations, viewer history, content searches, and device settings may be received and stored when the combination of mobile devices is determined to be proximate to a requesting device requesting or searching content.

For example, a husband and wife may be living at a user location. The husband may have a first mobile device and the wife may have a second mobile device. The system 100 may determine that when the husband is alone watching the display device 121 (e.g., based on the husband's mobile device being proximate to the requesting device), a first group of content items and types of content may be watched, reviewed, or searched and one or more devices 140 may be set at a first set of device settings. Similarly, the system 100 may determine that when the wife is alone watching the display device 121 (e.g., based on the wife's mobile device being proximate to the requesting device), a second group of content items and types of content may be watched, reviewed, or searched and one or more devices 140 may be set at a second set of device settings. The system 100 may determine that when the husband and wife are together watching the display device 121 (e.g., based on the husband's and wife's mobile devices being proximate to the requesting device), a third group of content items and types of content may be watched, reviewed, or searched and one or more devices 140 may be set at a third set of device settings. The system 100 may determine that when the husband and a friend are together watching the display device 121 (e.g., based on the husband's and the friend's mobile devices being proximate to the requesting device), a fourth group of content items and types of content may be watched, reviewed, or searched and one or more devices 140 may be set at a fourth set of device settings. As such, different profiles for each situation (husband alone, wife alone, husband and wife together, husband and friend together) may have different viewing history and different device setting histories and, as such, recommendations for content items, and settings for devices 140 may be different depending on the specific group of users determined (based on mobile device location) to be watching the display device 121.

The content discovery system 152 may evaluate the profile determined to include the identifiers for the mobile devices determined to be proximate to the requesting device. For example, the content discovery system 152 may evaluate the viewing history and/or search history for content items indicated in the profile and may determine a set of recommended content items. The content discovery system 152 may then send the recommendations of the content items to the requesting device for display on the display device and/or one of the mobile devices 124a-c. Accordingly, a specific set of recommendations as to content items or device settings may be determined and sent to the display device based on the group of users determined, based on the location of associated mobile devices, to be proximate to and likely watching the display of content on the display device 121.

The system 100 may have one or more content sources 127. The content source 127 may be configured to provide content (e.g., video, audio, games, applications, data) to the computing device for outputting content, such as the media device 120 and/or one or more mobile devices 124a-c. The content source 127 may be configured to provide streaming media, such as on-demand content (e.g., video on-demand), content recordings, and/or the like. The content source 127 may be managed by third party content providers, service providers, online content providers, over-the-top content providers, and/or the like. The content may be provided via a subscription, by individual item purchase or rental, and/or the like. The content source 127 may be configured to provide the content via a packet switched network path, such as via an internet protocol (IP) based connection. The content may be accessed by users via applications, such as mobile applications, television applications, set-top box applications, gaming device applications, and/or the like. An application may be a custom application (e.g., by content provider, for a specific device), a general content browser (e.g., web browser), an electronic program guide, and/or the like.

The system 100 may include one or more edge devices 128. Each edge device 128 may be configured to provide content, services, and/or the like to the user location 119 (e.g., to the computing device for outputting content, such as the media device 120 for display on the display device 121, and/or to one or more mobile devices 124a-c). Each edge device 128 may be one of a plurality of edge devices distributed across the network 116. Each edge device 128 may be located in a region proximate to or remote from the user location 119. A request for content from the user may be directed to one of the edge devices 128 (e.g., due to the location of the edge device and/or network conditions). Each edge device 128 may be configured to package content for delivery to the user (e.g., in a specific format requested by a user device), provide the user a manifest file (e.g., or other index file describing portions of the content), provide streaming content (e.g., unicast, multicast), provide a file transfer, and/or the like. For example, the packaging of content by the edge device 128 may include encrypting the content before it is sent to the user location 119. Each edge device 128 may cache or otherwise store content (e.g., frequently requested content) to enable faster delivery of content to users.

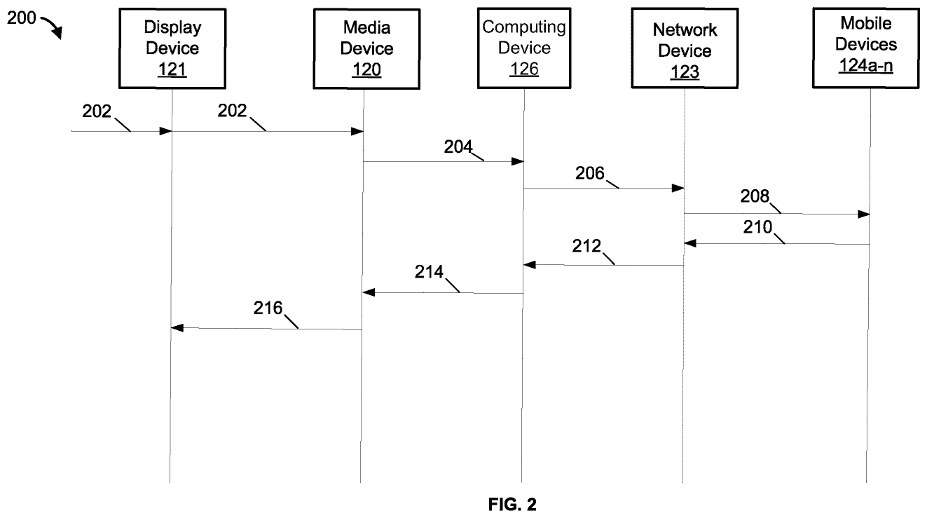

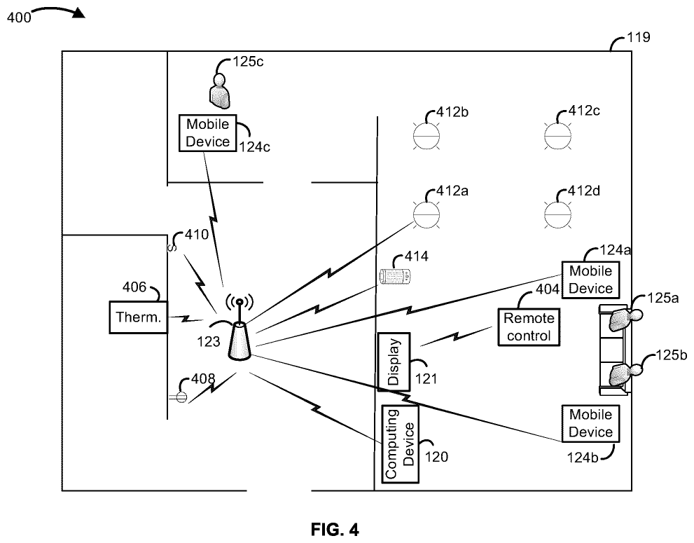

FIG. 2 shows an example communication method 200 for recommending content. FIG. 4 shows an example diagram 400 of an example user location 119. The user location 119 may be a premises, such as a user's residence or a place of business. The example communication method 200 may include one or more of a computing device for outputting content, such as the display device 121 and the media device 120, the application server 126 (or another computing device) the network device 123 and one or more mobile devices 124a-n. While certain actions are shown as being completed by certain devices within the example method 200 and diagram 400, this is for example purposes only, as any of the devices described herein may complete any one or all of the elements described herein.

A signal 202 may be sent. The signal 202 may be sent by a wired or wireless remote control device 404 associated with the display device 121 or media device 120. The signal 202 may be sent from a mobile device 124a via an application on the mobile device 124a. For example, if the signal 202 is sent from the mobile device 124a, the signal 202 may include an identifier (e.g., MAC address) of the mobile device 124a. The signal 202 may be received by the computing device for outputting content, such as the display device 121 or the media device 120. For example, the signal 202 may be received by the display device 121 and forwarded to the media device 120 via a wired or wireless communication, or may be directly received by the media device 120. The signal 202 may be an activation signal to turn on the display device 121 and/or media device 120. The signal 202 may be a request for content items or a recommendation of one or more content items to be received by the computing device for outputting content (e.g., the media device 120 or display device 121) for display at the display device 121. For example, the signal 202 may be a request for any type of content or information that may be provided to the computing device for outputting content, such as to the media device 120 for outputting at the display device 121. For example, the content or information may comprise one or more of audio content, video content, audio/video content, streaming content, website content, image content, or the like. For example, the signal 202 may be to search for and/or receive recommendations for content items.

A request 204 may be sent. For example, the request 204 may be sent by the computing device for outputting content, such as the media device 120 or the display device 121. For example, the request 204 may be received by the application server 126 or another computing device via the network 116. For example, the request 204 may be received by the content discovery system 152 of the application server 126. For example, the request may include a device identifier identifying the computing device for outputting content (e.g., the media device 120 or display device 121) that made the request 204. For example, the device identifier may be a MAC address, device name, device number, user account number, user name or the like. For example, the request 204 may include signal level data for the computing device for outputting content, such as the media device 120 and/or display device 121. For example, the signal level data may include the SNR for the computing device for outputting content, such as the media device 120 and/or the display device 121, the RSSI for the computing device for outputting content, and/or the antenna of the network device (e.g., the access point 123 that receives the signals from the computing device for outputting content, such as the media device 120 and/or display device 121. For example, the application server 126 may know a location of the computing device for outputting content within the user location 119 and the SNR, RSSI, and/or antenna of the network device that would indicate a device is proximate to (e.g., near, in the same room, adjacent to, or within a particular distance of) the computing device for outputting content. The request 204 may be for content items or suggested content items to present at the display device 121. For example, the request 204 may be a request for what content items to offer or display on the display device 121, a request to browse content items, a request to search content items, etc.

The application server 126 (e.g., the content discovery system 152) may determine the location associated with the request 204. For example, the application server 126 may determine that the request 204 came from the user location 119. The application server 126 may determine one or more network devices (e.g., access points 123) located at the location 119. For example, a network address for the network devices associated with and/or co-located with the computing device for outputting content (e.g., the media device 120 and/or display device 121) that sent the request 204 may be stored in a profile in the profile management system 154. For example, the application server 126 may determine the one or more network devices (e.g., access point 123) to use based on the identifier of the computing device for outputting content (e.g., the media device 120 or display device 121) in the request 204.

A request 206 may be sent. The request 206 may be sent by the application server 126. For example, the request 206 may be sent by the device diagnostics engine 151 of the application server 126. The request 206 may be received by the network device (e.g., the access point 123) via the network 116 or another network. For example, the request 206 may be received by the media device 120 or the display device 121 if the media device 120 or display device 121 includes an embedded access point 123. For example, the request 206 may be sent based on a determination that the request 204 was received from a location (e.g., the user location 119) associated with the access point 123. For example, the request 206 may be a request for an indication of the wireless communication devices (e.g., stationary wireless communication devices and mobile devices) communicating with the access point 123. For example, the request 206 may be sent to multiple access points within the user location 119. Sending the request 206 to multiple access points 123 within the user location may allow for triangulation of and more precise determination of the location of each of the wireless communication devices (e.g., the mobile devices, such as mobile devices 124a-c and the stationary devices, such as the device 140, such as the media device 120, the display device 121, the thermostat 406, one or more receptacles 408, one or more switches 410, one or more luminaires 412a-d, a fan, a smart speaker 414, a security system, or the like).

The one or more network devices (e.g., access points 123) at the user location 119 receiving the request 206 may send out a request 208 to identify the wireless communication devices (e.g., the stationary wireless devices such as device 140, the media device 120, the display device 121, the thermostat 406, one or more receptacles 408, one or more switches 410, one or more luminaires 412a-d, a fan, a smart speaker 414, a security system, or the like and the mobile devices (e.g., the mobile devices 124a-c)) within communication range of the particular access point 123. For example, the request 206 may be a ping or some other form or request initiating a response from the wireless communication devices.

The one or more wireless communication devices (e.g., the stationary wireless devices, which may include the media device 120, the display device 121, the thermostat 406, one or more receptacles 408, one or more switches 410, one or more luminaires 412a-d, a fan, a smart speaker 414, a security system, and/or the like, and the mobile devices, such as mobile devices 124a-c) may send a response 210 to the network device (e.g., the access point). The response 210 may be sent based on the request. In certain examples, the response 210 may be sent to the access point 123 without the access point needing to send the request 208 to the wireless communication devices. One or more access points 123 at the user location 119 may receive the response 210 from each of the wireless communication devices. The response 210 may include an indication of the wireless communication device that sent the response 210. For example, the indication may be an identifier of the wireless communication device sending the response 210. For example, the identifier of the wireless communication device may be the MAC address for the device, another unique identifier of the device, a URL associated with the device, a user name associated with the device, or an account identifier associated with the device. For each response 210 received from each wireless communication device, the particular access point 123 may determine signal level data associated with the response 210. For example, the signal level data associated with the response 210 may include which antenna of the access point 123 received the response 210, the SNR, the RSSI, or other similar signal data.

Each network device (e.g., access point 123) receiving the request 206 may send a response 212, via the communication terminal 122. The response 212 may be sent to the application server 126 via the network 116 or another network. For example, the response 212 may be received by the device diagnostic engine 151 of the application server 126. For example, the response 212 may comprise a plurality of responses, each associated with one of the wireless communication devices communicating with the particular access point 123. Each response 212 may include the indication of the one or more wireless communication devices communicating with the access point 123 and the signal level data associated with that particular wireless communication device for the response 210 received from the particular wireless communication device.

The application server 126 may determine the one or more mobile devices (e.g., mobile devices 124a-b, located proximate to the computing device for outputting content (e.g., the media device 120 and/or display device 121) from which the request 204 was received or associated. For example, the Wi-Fi device manager 153 may determine which of the wireless communication devices communicating with the access point are mobile devices (e.g., mobile devices 124a-c) or are not stationary wireless communication devices (e.g., the media device 120, display device 121, the one or more other devices 140, such as the thermostat 406, one or more receptacles 408, one or more switches 410, one or more luminaires 412a-d, a fan, a smart speaker 414, a security system, or the like, etc. For example, the Wi-Fi device manager 153 or another portion of the application server 126 may determine which of the wireless communication devices provided by the access point 123 have not moved for a threshold period of time (e.g., a day, a week, a month, etc.) and may classify these devices as stationary wireless communication devices.

The content discovery system 152 may compare the signal level data received in the request 204 and/or the known location of the computing device for outputting content (e.g., the display device 121 and/or media device 120) to the signal level data for the one or more determined mobile devices (e.g., mobile devices 124a-c) connected at the access point(s) 123 at the user location 119 to determine which mobile devices 124a-c are near or proximate the computing device for outputting content, such as the media device 120 or display device 121 (and thus likely having an associated user watching the content on the display device 121) from which the request 204 was received. For example, the content discovery system 152 may determine which mobile devices 124a-c have an RSSI and/or SNR that is within a predetermined threshold of the RSSI and/or SNR of the requesting device (e.g., the computing device for outputting content, such as the media device 120 or display device 121) or an RSSI and/or SNR within a predetermined threshold position value for the expected RSSI and/or expected SNR for the known position of the computing device for outputting content with respect to a particular access point 123 in the user location 119. For example, the threshold may be a particular value, amount, or percentage from which the RSSI and/or SNR may vary from the RSSI and/or SNR of the requesting device or the expected RSSI/expected SNR. For example, the content discovery system 152 may also determine which antenna of the access point 123 the signal was received from the requesting device and the mobile devices 124a-c to determine the location of the mobile devices 124a-c with respect to the computing device for outputting content, such as the media device 120 and/or display device 121, associated with the request 204. For example, the content discovery system 152 may not consider mobile devices, such as mobile device 124c, whose signal was received by a different antenna of the access point 123 as that of the computing device for outputting content, such as the media device 120 and/or display device 121, or the expected antenna based on a known location of the computing device for outputting content, to be proximate to the computing device for outputting content and thus the users, such as user 125c, associated with those mobile devices 124c are likely not watching the content on the display device 121. For example, the content discovery system 152 may not consider mobile devices, such as mobile device 124c, based on the RSSI value of the signal received from mobile device 124c. For example, the RSSI value for the signal received from mobile device 124c may not be within a threshold value of the RSSI value of the communication received from the computing device for outputting content, indicating the mobile device 124c is not proximate to the computing device for outputting content, and thus, the user associated with mobile device 124c is likely not watching the content on a display associated with the computing device for outputting content. For example, the content discovery system 152 may not consider mobile devices, such as mobile device 124c, based on the SNR value of the signal received from mobile device 124c. For example, the SNR value for the signal received from mobile device 124c may not be within a threshold value of the SNR value of the communication received from the computing device for outputting content, indicating the mobile device 124c is not proximate to the computing device for outputting content, and thus, the user associated with mobile device 124c is likely not watching the content on a display associated with the computing device for outputting content. In situations where signals from a mobile device (e.g., mobile devices 124a-c) were received by multiple access points 123 within a location 119, the content discovery system 152 may triangulate the signal to determine the location of the mobile device with respect to the computing device for outputting content (e.g., the media device 120 and/or display device 121) associated with the request 204 to determine if the particular mobile device is within a threshold distance of the computing device for outputting content to be considered proximate or near thereto.

Based on the identifiers (e.g., MAC address, device identifier, device name, account number, etc.) of the mobile devices 124a-c determined to be proximate to the computing device for outputting content (e.g., media device 120 or display device 121), the content discovery system 152 may determine a profile, from the profile management system 154, that is based on or associated with (e.g., matches) the one user or combination of users associated with the mobile devices determined to be proximate to the computing device for outputting content. For example, if mobile devices 124a and 124b (see FIG. 4) are determined to be near or proximate to the requesting device (e.g., the computing device for outputting content, such as the media 120 or display device 121), the content discovery system 152 will look for a profile that is based on or associated with (e.g., includes) both the user associated with mobile device 124a and the user associated with mobile device 124b, and no additional devices or users. For example, the content discovery system 152 may look for a profile that has mobile device identifiers that match the mobile device identifiers (e.g., MAC address, device identifier, device name, account number, etc.) for the mobile devices 124a and 124b.

For example, if a profile associated with the combination of mobile device 124a and 124b has not yet been created, then the profile management system 154 may create or determine a new profile for the combination of mobile device 124a and 124b and begin associating data with the profile. For example, if individual profiles have previously been stored for mobile device 124a and mobile device 124b, data such as user names, user identifiers (e.g., an account ID, phone number, address, a unique identifier), mobile devices associated with the particular user name, user demographics (e.g., age, sex, race, national origin), locations (e.g., user location 119) of the user, viewing history or searches for the particular user, device settings for one or more devices associated with the particular user (e.g., in locations where the user has been), and the like. For example, when initially creating a profile for a combination of mobile devices, the initial viewing history may be content items or content genres (e.g., sports, movies, sitcoms, dramas, reality shows, etc.) that are included in each (e.g., matching in each) of the individual profiles associated with each of the combination of mobile devices. Once a profile is created or determined for the particular combination of mobile devices 124a, 124b, subsequent locations, viewer history, content searches, and device settings may be received and stored when the combination of mobile devices 124a, 124b is determined to be near/proximate a requesting device requesting or searching content.

For example, a husband and wife may be living at a user location. The husband may have a first mobile device and the wife may have a second mobile device. The system 100 may determine that when the husband is alone watching the display device 121 (e.g., based on the husband's mobile device being near/proximate to the computing device for outputting content, such as the media device 120 and/or display device 121), a first group of content items and types of content may be watched, reviewed, or searched and one or more devices 140 may be set at a first set of device settings. Similarly, the system 100 may determine that when the wife is alone watching the display device 121 (e.g., based on the wife's mobile device being near/proximate to the computing device for outputting content, second group of content items and types of content may be watched, reviewed, or searched and one or more devices 140 may be set at a second set of device settings. The system 100 may determine that when the husband and wife are together watching the display device 121 (e.g., based on the husband's and wife's mobile devices being near/proximate to the computing device for outputting content), a third group of content items and types of content may be watched, reviewed, or searched and one or more devices 140 may be set at a third set of device settings. The system 100 may determine that when the husband and a friend are together watching the display device 121 (e.g., based on the husband's and the friend's mobile devices being near/proximate to the computing device for outputting content), a fourth group of content items and types of content may be watched, reviewed, or searched and one or more devices 140 may be set at a fourth set of device settings. As such, different profiles for each situation (husband alone, wife alone, husband and wife together, husband and friend together) may have different viewing history and different device setting histories and, as such, recommendations for content items, and settings for devices 140 may be different depending on the specific group of users determined (based on mobile device location) to be watching the display device 121.

The content discovery system 152 may evaluate the profile determined to include the identifiers for the mobile devices (e.g., mobile devices 124a, 124b) determined to be near/proximate to the computing device for outputting content, such as the media device 120 and/or display device 121. For example, the content discovery system 152 may evaluate the viewing history and/or search history for content items indicated in the profile and may determine a set of recommended content items to be sent back to the computing device for outputting content (e.g., the media device 120 and display device 121) for presentation to the one or a group of users 125a-b. For example, the content discovery system 152 may evaluate the device setting history of the profile to determine one or more settings for the one or more devices 140 when the one or group of mobile devices (e.g., mobile devices 124a-b) are determined to be near/proximate to the computing device for outputting content, such as the media device 120 and/or display device 121. For example, the settings may include any one or more of the device being turned on, the device being turned off, the device level, the temperature setting for the device, etc. For example, the device 140 may be any one of an IoT device, thermostat 406, luminaire 412a-d, smart speaker 414, switch 410, electrical receptacle 408, fan, smart appliance, security system, or the like. For example, based on the device setting history, the content discovery system 152 may determine one or more device settings for one or more devices 140 to change for presentation to the one or a group of users 125a-b.

The application server 126 may send content 214. For example, the content 214 may include the one or more recommended content items determined based on the identified profile. For example, the content may include a recommendation of the one or more device settings for one or more devices 140 to change based on the determined mobile devices near/proximate to the computing device for outputting content, such as the media device 120 and/or display device 121. The content 214 may be sent to the computing device for outputting content. In certain examples, the content 214 may be sent based on one or more of the requests 202, 204. For example, the content 214 may be sent to the media device 120 and the media device 120 may prepare and/or forward the content 216 for display at the display device 121. For example, the content 214, 216 comprising the one or more recommended content items and the recommended device settings may also be sent to the one or more mobile devices associated with the determined profile via the network 116 or another network.

A selection of one or more of the recommended content items may be received at the computing device for outputting content, such as the media device 120 or the display device 121. The selected content item may be requested from and received from a content source 127 at the computing device for outputting content and displayed on the display device 121. An indication of the requested content may also be sent by the media device 120 to the application server 126 via the network 116 or another network and added to the viewing history portion of the profile associated with the mobile devices near/proximate to the computing device for outputting content, such as the media device 120 and/or display device 121.

A request may be received to change one or more settings of the one or more devices 140, such as the thermostat 406, one or more receptacles 408, one or more switches 410, one or more luminaires 412a-d, a fan, a smart speaker 414, a security system, or the like. For example, the request may be received by the computing device for outputting content, such as the media device 120 and/or the display device 121, via a remote control device 404. For example, the request may be received via an application on one of the mobile devices 124a-b near/proximate to the computing device for outputting content. For example, the request to change one or more settings of one or more devices 140 may be sent from the computing device for outputting content to the access point 123. The access point 123 may be in wireless communication with the one or more devices 140 and may send the request to change the device setting to each particular device 140 in the request. For example, the request may include a request to change the temperature on a thermostat 406, to turn on/off one or more luminaires 412a-d (e.g., lights), to adjust the light level of one or more luminaires 412a-d, to change a setting on a fan, to change a volume of a smart speaker 414, to change a setting on a smart appliance, to change a setting on a security system for the location 119, to activate/deactivate one or more switches 410 or electrical receptacles 408 or change one or more other device settings on another device 140.

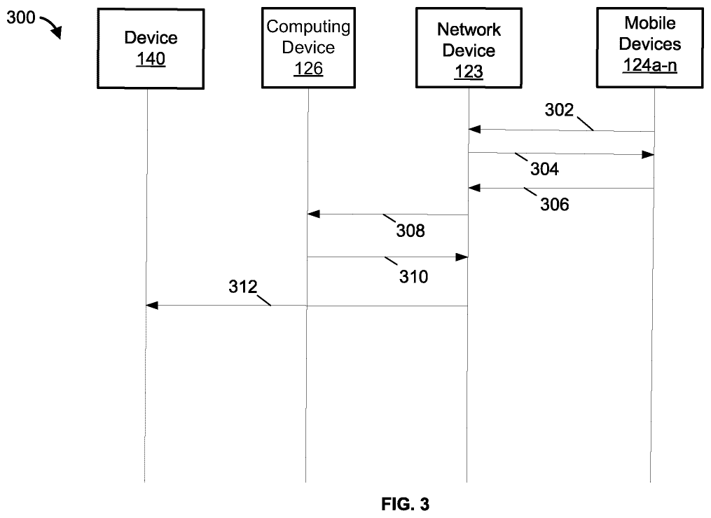

FIG. 3 shows an example communication method 300 for modifying the operational setting of one or more devices, such as devices 140. The example communication method 300 may include one or more of the application server 126 (or another computing device) the network device 123, and one or more mobile devices 124a-n. While certain actions are shown as being completed by certain devices within the example method 300, this is for example purposes only, as any of the devices described herein may complete any one or all of the elements described herein.

As one or more mobile devices (e.g., mobile device 124a) move within range of an access point 123, a request 302 may be sent from the mobile device 124a to the access point 123. For example, the mobile device 124 may be with a user 125a and as the user enters the user location 119 or passes by a particular room of area of the user location 119, the mobile device may move within range of the access point 123. For example, the user location 119 may be a premises, such as a residence or business. The request 302 may include a probe request or an association request. The request 302 may be received by the access point 123. The request 302 may include an identifier of the mobile device 124a. For example, the identifier may include a MAC address of the mobile device 124a, another unique identifier of the mobile device, a user name associated with the mobile device, or an account identifier associated with the mobile device.

The one or more network devices (e.g., access points 123) at the user location 119 may send out a request 304 to identify the wireless communication devices (e.g., the stationary wireless devices and the mobile devices (e.g., the mobile devices 124a-c)) within communication range of the particular access point 123. For example, the request 304 may be a ping or some other form or request initiating a response from the wireless communication devices. For example, the request 304 may be sent based on the access point 123 receiving the request 302 from the mobile device 124a when the mobile device 124a enters within or comes into detection range of the access point 123

The one or more wireless communication devices (e.g., the stationary wireless devices, which may include the media device 120, the display device 121, or one or more devices 140, such as the thermostat 406, one or more receptacles 408, one or more switches 410, one or more luminaires 412a-d, a fan, a smart speaker 414, a security system, and/or the like, and the mobile devices, such as mobile devices 124a-c) may send a response 306 to the network device (e.g., the access point 123). The response 306 may be sent based on the request 304. In certain examples, the response 306 may be sent to the access point 123 without the access point needing to send the request 304. One or more access points 123 at the user location 119 may receive the response 306 from each of the wireless communication devices. The response 306 may include an indication of the wireless communication device that sent the response 306. For example, the indication may be an identifier of the wireless communication device sending the response 306. For example, the identifier of the wireless communication device may be the MAC address for the device, another unique identifier of the device, a URL associated with the device, a user name associated with the device, or an account identifier associated with the device. For each response 306 received from each wireless communication device, the particular access point 123 may determine signal level data associated with the response 306. For example, the signal level data associated with the response 306 may include which antenna of the access point 123 received the response 306, the SNR, the RSSI, or other similar signal data.

The access point 123 receiving the request 302 may send a request 308. The request 308 may be sent to the application server 126 via the network 116 or another network. For example, the request 308 may be received by the device diagnostic engine 151 of the application server 126. For example, the request 308 may comprise a plurality of responses 306, each associated with one of the wireless communication devices communicating with the particular access point 123. The request 308 may include the indication of the one or more wireless communication devices communicating with the access point 123 and the signal level data associated with that particular wireless communication device for the response 306 received from the particular wireless communication device.

The application server 126 may determine the one or more mobile devices located at the user location 119, a particular portion of the user location 119 (e.g., a room or section) and/or proximate to the access point 123. For example, the Wi-Fi device manager 153 may determine which of the wireless communication devices communicating with the access point 123 are mobile devices (e.g., mobile devices 124a-c) or are not stationary wireless communication devices (e.g., the media device 120, display device 121, the one or more devices 140, etc. For example, the Wi-Fi device manager 153 or another portion of the application server 126 may determine which of the wireless communication devices provided by the access point 123 have not moved for a threshold period of time (e.g., a day, a week, a month, etc.) and may classify these devices as stationary wireless communication devices.

The content discovery system 152 may compare the known location of the access point 123 within the user location 119 to the signal level data for the one or more determined mobile devices (e.g., mobile devices 124a-c) connected at the access point(s) 123 at the user location 119 to determine which mobile devices 124a-c are at the user location 119, a particular portion of the user location 119 (e.g., a room or section) and/or proximate to the access point 123. For example, the content discovery system 152 may determine which mobile devices 124a-c have an RSSI and/or SNR within a predetermined threshold position value for the expected RSSI and/or expected SNR for a mobile device within the user location 119, a particular portion of the user location 119 (e.g., a room or section) and/or proximate to the access point 123. For example, the threshold may be a particular value, amount, or percentage from which the RSSI and/or SNR may vary from the expected RSSI/expected SNR. For example, the content discovery system 152 may also determine which antenna of the access point 123 the signal was received from the requesting device and the mobile devices 124a-c to determine the location of the mobile devices 124a-c with respect to the user location 119, a particular portion of the user location 119 (e.g., a room or section) and/or proximate to the access point 123.

In situations where signals from a mobile device (e.g., mobile devices 124a-c) were received by multiple access points 123 within a location 119, the content discovery system 152 may triangulate the signal to determine the location of the mobile device with respect to the user location 119, a particular portion of the user location 119 (e.g., a room or section) and/or the access point 123 to determine if the particular mobile device is within the user location 119, the particular part of the user location 119 and/or a threshold distance of the access point 123.

Based on the identifiers (e.g., MAC address, device identifier, device name, account number, etc.) of the mobile devices 124a-c determined to be at the user location 119, a particular portion of the user location 119 (e.g., a room or section) and/or proximate to the access point 123, the content discovery system 152 may determine a profile, from the profile management system 154, that is based on or associated with (e.g., matches) the one user or combination of users associated with the mobile devices determined to be at the user location 119, a particular portion of the user location 119 (e.g., a room or section) and/or proximate to the access point 123. For example, if mobile devices 124a and 124b are determined to be near or proximate to the access point 123 (or within the user location 119 or a particular portion of the user location 119), the content discovery system 152 will look for a profile that is based on or associated with (e.g., includes) both the user associated with mobile device 124a and the user associated with mobile device 124b, and no additional devices or other users. For example, the content discovery system 152 may look for a profile that has mobile device identifiers that match the mobile device identifiers (e.g., MAC address, device identifier, device name, account number, etc.) for the mobile devices 124a and 124b. In certain examples, a particular user may not be yet associated with a profile that is associated with a mobile device identifier of a mobile device. That is, there may be situations where the mobile device is detected and one or more profiles that include the mobile device identifier for the particular mobile device (e.g., alone and in combination with one or more other mobile devices) before a particular user is identified as being associated with the particular mobile device.

For example, if a profile associated with the combination of mobile device 124a and 124b has not yet been created, then the profile management system 154 may create or determine a new profile for the combination of mobile device 124a and 124b and begin associating data with the profile. Once a profile is created or determined for the particular combination of mobile devices 124a, 124b, subsequent locations, viewer history, content searches, and device settings may be received and stored when the combination of mobile devices 124a, 124b is determined to be near/proximate to a requesting device requesting or searching content.

For example, a husband and wife may be living at a user location 119. The husband may have a first mobile device and the wife may have a second mobile device. The system 100 may determine that when the husband is alone in the user location 119 or a portion of the user location 119, one or more devices 140 may be set at a first set of device settings. Similarly, the system 100 may determine that when the wife is alone in the user location 119 or a portion of the user location 119, one or more devices 140 may be set at a second set of device settings. The system 100 may determine that when the husband and wife are together in the user location 119 or a portion of the user location 119, one or more devices 140 may be set at a third set of device settings. The system 100 may determine that when the husband and a friend are together in the user location 119 or a portion of the user location 119, one or more devices 140 may be set at a fourth set of device settings. As such, different profiles for each situation (husband alone, wife alone, husband and wife together, husband and friend together) may have different device setting histories and, as such, recommendations for settings for devices 140 may be different depending on the specific group of users determined (based on mobile device location) to at the user location 119 or a specific portion of the user location 119.

The content discovery system 152 may evaluate the profile determined to include the identifiers for the mobile devices (e.g., mobile devices 124a, 124b) determined to be at the user location 119, a particular portion of the user location 119, and/or proximate the access point 123. For example, the content discovery system 152 may evaluate the device setting history of the profile to determine one or more settings for the one or more devices 140 when the one or group of mobile devices are determined to be at the user location 119, a particular portion of the user location 119, and/or proximate the access point 123. For example, the settings may include any one or more of the device being turned on, the device being turned off, the device level, the temperature setting for the device, etc. For example, the device 140 may be any one of an IoT device, thermostat, luminaire, smart speaker, switch, electrical receptacle, fan, smart appliance, security system, or the like. For example, based on the device setting history, the content discovery system 152 may determine one or more device settings for one or more devices 140 to change for presentation to the one or a group of users 125a-b.

The application server 126 may send a response 310. For example, the response 310 may include a recommendation of the one or more device settings for one or more devices 140 to change based on the determined mobile devices near/proximate to the computing device for outputting content, such as the media device 120 and/or display device 121. For example, the response 310 may include instructions or embedded requests to change one or more device settings for one or more devices 140 based on the determined mobile devices at the user location 119, a particular portion of the user location 119, and/or proximate the access point 123. The response 310 may be sent to the access point 123. In certain examples, the response 310 may be sent based on the request 308. For example, the response 310 comprising the one or more recommended device settings may be sent to the one or more mobile devices associated with the determined profile via the network 116 or another network.

For example, the access point 123 may receive the response 310. The access point 123 may wirelessly transmit instructions 312 to the one or more devices 140 to change a device setting associated with that particular device 140.

For example, the mobile device 124a may receive the one or more device setting recommendations from the access point 123. The mobile device 124a may receive an input or selection indicating a desire by the user 125a to change a device setting of one or more devices 140. The mobile device 124 may send the indicator or instruction to change the one or more device settings for one or more devices 140 to the access point 123. The access point 123 may receive the indicator or instruction and may send one or more instructions 312 to one or more devices 140 to change a device setting of that particular device 140. For example, the instructions 312 may include an instruction to change the temperature on a thermostat, to turn on/off one or more luminaires (e.g., lights), to adjust the light level of one or more luminaires, to change a setting on a fan, to change a setting on a smart appliance, to change a setting on a security system for the location 119, to activate/deactivate one or more switches or electrical receptacles or change one or more other device settings on another device 140.

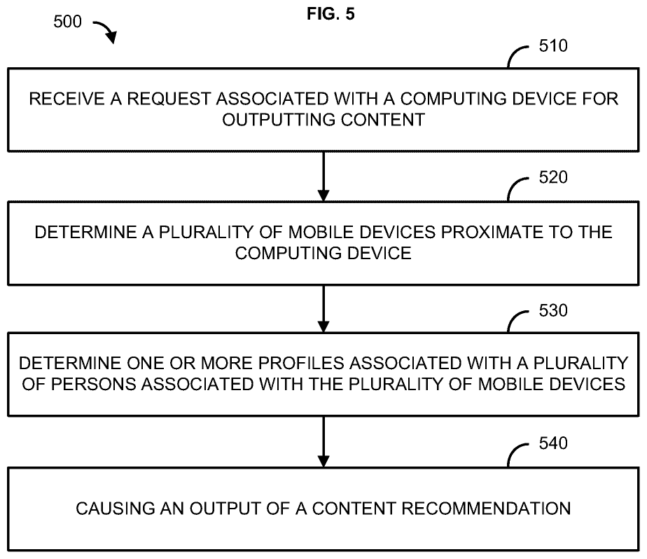

FIG. 5 shows a flowchart of an example method 500 for determining a profile associated with users viewing content. For example, the method 500 may be completed by a computing device, such as the application server 126, the central location 101, or the computing device for outputting content. At 510, a request associated with the computing device for outputting content may be received. For example, the request may be received by the application server 126 or another computing device. For example, the computing device for outputting content may comprise the media device 120 and/or the display device 121. For example, the request may be sent by the computing device for outputting content. For example, the request may be received by the content discovery system 152 of the application server 126. The request may be for content items or a recommendation of content items to be received by the computing device for outputting content. For example, the computing device for outputting content may cause the content items or the recommendation of the content items to be displayed on a display, such as the display device 121. For example, the request may be a request for what content items to offer or display, a request to browse content items, a request to search content items, etc.

For example, the request may be based on a signal received by the computing device for outputting content, such as the display device 121 or the media device 120. For example, the signal may be based on a direct input at the computing device for outputting content via an input device, such as a keyboard or mouse, or from a wireless or wired remote control 404. For example, the signal may be received by the display device 121 and forwarded to the media device 120 via a wired or wireless communication, or may be directly received by the media device 120. The signal may be an activation signal to turn on the display device 121 and/or media device 120. The signal may be a request for content items to be received by the computing device for outputting content (e.g., the media device 120 or display device 121) for output at the display device 121. For example, the signal may be a request for any type of content or information that may be received by the computing device for outputting content for output at the display device 121, such as audio content, video content, audio/video content, streaming content, website content, image content, or the like. For example, the signal may be to search for and/or receive recommendations for one or more content items.

For example, the request may include a device identifier identifying the computing device for outputting content, such as the media device 120 or display device 121, making the request. For example, the device identifier may be a MAC address, device name, device number, user account number, user name or the like. For example, the request may include signal level data for the computing device for outputting the content. For example, the signal level data may include the SNR for the computing device for outputting content (e.g., the media device 120 and/or the display device 121), the RSSI for the computing device for outputting content, and/or the antenna of the network device (e.g., the access point 123) that receives the signals from the computing device for outputting content. For example, the application server 126 may know a location of the computing device for outputting content within the user location 119 and the SNR, RSSI, and/or antenna of the network device that would indicate a device is proximate to (e.g., near, in the same room, adjacent to, or within a particular distance of) the computing device for outputting content, such as the media device 120 and/or display device 121.

At 520, a plurality of mobile devices proximate to the computing device for outputting content may be determined. For example, the plurality of mobile devices proximate to the computing device for outputting content may be determined by a computing device, such as the application server 126, the central location 101, or the media device 120. For example, the application server 126 (e.g., the content discovery system 152) may determine the location associated with the received request. For example, the application server 126 may determine that the received request came from the user location 119. The application server 126 may determine one or more network devices (e.g., access points 123) located at the user location 119. For example, a network address for the network devices associated with and/or co-located with the computing device for outputting content, such as the media device 120 and/or display device 121, that sent the request may be stored in a profile in the profile management system 154. For example, the application server 126 may determine the one or more network devices (e.g., access point 123) to use based on the identifier of the media device 120 or display device 121 in the received request.

For example, a request may be sent by the application server 126 and received by the network device (e.g., the access point 123) via the network 116 or another network. For example, the request may be sent based on a determination that the request 204 was received from a location (e.g., the user location 119) associated with the access point 123. For example, the request may be a request for an indication of the wireless communication devices (e.g., stationary wireless communication devices and mobile devices) communicating with the access point 123. For example, the request may be sent to multiple access points within the user location 119.

The one or more network devices (e.g., access points 123) at the user location 119 receiving the request may identify the wireless communication devices (e.g., the stationary wireless devices such as device 140, the media device 120, the display device 121, the thermostat 406, one or more receptacles 408, one or more switches 410, one or more luminaires 412a-d, a fan, a smart speaker 414, a security system, or the like) and the mobile devices (e.g., the mobile devices 124a-c)) within communication range of the particular access point 123.

For example, the application server 126 or the one or more network devices (e.g., access points 123) may be configured to determine if a device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

For example, the one or more wireless communication devices (e.g., the stationary wireless devices and the mobile devices) may send a response to the network device (e.g., the access point 123) that includes an indication of the wireless communication device that sent the response. For example, the indication may be an identifier of the wireless communication device sending the response. For example, the identifier of the wireless communication device may be the MAC address for the device, another unique identifier of the device, a URL associated with the device, a user name associated with the device, or an account identifier associated with the device. For each response received from each wireless communication device, the particular access point 123 may determine signal level data associated with the response, such as which antenna of the access point 123 received the response, the SNR of the response, the RSSI of the response, or other similar signal data.

The application server 126 may receive a response, via the network 116 or another network, from the one or more network devices (e.g., access points 123) of the user location 119. For example, the response may be received by the device diagnostic engine 151 of the application server 126. For example, the response may comprise a plurality of responses, each associated with one of the wireless communication devices communicating with the particular access point 123. Each response may include the indication of the one or more wireless communication devices communicating with the access point 123 and the signal level data associated with that particular wireless communication device.

The application server 126 may determine the one or more mobile devices (e.g., mobile devices 124a-b, located proximate to the computing device for outputting content, such as the media device 120 and/or display device 121, from which the request was received or associated. For example, the Wi-Fi device manager 153 of the application server 126 may determine which of the wireless communication devices communicating with the access point are mobile devices (e.g., mobile devices 124a-c) or are not stationary wireless communication devices (e.g., the media device 120, display device 121, the one or more other devices 140, such as the thermostat 406, one or more receptacles 408, one or more switches 410, one or more luminaires 412a-d, a fan, a smart speaker 414, a security system, or the like, etc.). For example, the Wi-Fi device manager 153 may determine which of the wireless communication devices provided by the access point 123 have not moved for a threshold period of time (e.g., a day, a week, a month, etc.) and may classify these devices as stationary wireless communication devices.

The content discovery system 152 of the application server 126 may compare the signal level data received in the request from the computing device for outputting content and/or the known location of the computing device for outputting content (e.g., the display device 121 and/or media device 120) to the signal level data for the one or more determined mobile devices (e.g., mobile devices 124a-c) connected at the access point(s) 123 at the user location 119 to determine which mobile devices 124a-c are near or proximate to the computing device for outputting content (and thus likely having an associated user watching the content on the display device 121) from which the request was received. For example, the content discovery system 152 may determine which mobile devices 124a-c have an RSSI and/or SNR that is within a predetermined threshold of the RSSI and/or SNR of the requesting device (e.g., the computing device for outputting content, such as the media device 120 or display device 121) or an RSSI and/or SNR within a predetermined threshold position value for the expected RSSI and/or expected SNR for the known position of the computing device for outputting content with respect to a particular access point 123 in the user location 119. For example, the threshold may be a particular value, amount, or percentage from which the RSSI and/or SNR may vary from the RSSI and/or SNR of the requesting device (e.g., the computing device for outputting content) or the expected RSSI/expected SNR. For example, the content discovery system 152 may also determine which antenna of the access point 123 the signal was received from the computing device for outputting content and the mobile devices 124a-c to determine the location of the mobile devices 124a-c with respect to the computing device for outputting content (e.g., the media device 120 and/or display device 121) associated with the request 204. For example, the content discovery system 152 may not consider mobile devices, such as mobile device 124c, whose signal was received by a different antenna of the access point 123 as that of the computing device for outputting content (e.g., the media device 120 and/or display device 121), or the expected antenna based on a known location of the computing device for outputting content, to be proximate to the requesting device and thus the users, such as user 125c (see FIG. 4), associated with those mobile devices 124c are likely not watching the content on the display device 121. For example, the content discovery system 152 may not consider mobile devices, such as mobile device 124c, based on the RSSI value of the signal received from mobile device 124c. For example, the RSSI value for the signal received from mobile device 124c may not be within a threshold value of the RSSI value of the communication received from the computing device for outputting content, indicating the mobile device 124c is not proximate to the computing device for outputting content, and thus, the user associated with mobile device 124c is likely not watching the content on a display associated with the computing device for outputting content. For example, the content discovery system 152 may not consider mobile devices, such as mobile device 124c, based on the SNR value of the signal received from mobile device 124c. For example, the SNR value for the signal received from mobile device 124c may not be within a threshold value of the SNR value of the communication received from the computing device for outputting content, indicating the mobile device 124c is not proximate to the computing device for outputting content, and thus, the user associated with mobile device 124c is likely not watching the content on a display associated with the computing device for outputting content.

In situations where signals from a mobile device (e.g., mobile devices 124a-c) were received by multiple access points 123 within a location 119, the content discovery system 152 may triangulate the signal to determine the location of the mobile device with respect to the computing device for outputting content (e.g., the media device 120 and/or display device 121) to determine if the particular mobile device is within a threshold distance of the computing device for outputting content to be considered proximate or near thereto.

At 530, a profile associated with a plurality of persons may be determined. For example, the profile may be determined by a computing device, such as the application server 126, the central location 101, or the media device 120. For example, the application server 126 may determine a profile based on the identifiers (e.g., MAC address, device identifier, device name, account number, etc.) of the mobile devices 124a-c determined to be proximate to the computing device for outputting content, such as the media device 120 or display device 121. For example, the application server 126 may determine a profile, from the profile management system 154, that is based on or associated with (e.g., matches) the combination of users associated with the mobile devices determined to be proximate to the computing device for outputting content. For example, if mobile devices 124a and 124b (see FIG. 4) are determined to be near or proximate to the computing device for outputting content, the content discovery system 152 will look for a profile that is based on or associated with (e.g., includes) both the user associated with mobile device 124a and the user associated with mobile device 124b, and no additional devices or users. For example, the content discovery system 152 may look for a profile that has mobile device identifiers that match the mobile device identifiers (e.g., MAC address, device identifier, device name, account number, etc.) for the mobile devices 124a and 124b.

For example, if a profile associated with the combination of mobile device 124a and 124b has not yet been created, then the profile management system 154 may create or determine a new profile for the combination of mobile device 124a and 124b and begin associating data with the profile. For example, if separate, individual profiles have previously been stored for mobile device 124a and mobile device 124b, data such as user names, user identifiers (e.g., an account ID, phone number, address, a unique identifier), mobile devices associated with the particular user name, user demographics (e.g., age, sex, race, national origin), locations (e.g., user location 119) of the user, viewing history or searches for the particular user, device settings for one or more devices associated with the particular user (e.g., in locations where the user has been), and the like may be retrieved from those individual profiles and added to the new profile for the combined group of the user 125a associated with the mobile device 124a and the user 125b associated with the mobile device 124b. For example, when initially creating a profile for a combination of mobile devices, the initial viewing history may be content items or content genres (e.g., sports, movies, sitcoms, dramas, reality shows, etc.) that are included in each (e.g., matching in each) of the individual profiles associated with each of the combination of mobile devices. Once a profile is created or determined for the particular combination of mobile devices 124a, 124b, subsequent locations, viewer history, content searches, and device settings may be received and stored when the combination of mobile devices 124a, 124b is determined to be near/proximate to a requesting device requesting or searching content.

For example, a husband and wife may be living at a user location. The husband may have a first mobile device and the wife may have a second mobile device. The system 100 may determine that when the husband is alone watching the display device 121 (e.g., based on the husband's mobile device being near/proximate to the computing device for outputting content, such as the media device 120 and/or display device 121), a first group of content items and types of content may be watched, reviewed, or searched and one or more devices 140 may be set at a first set of device settings. Similarly, the system 100 may determine that when the wife is alone watching the display device 121 (e.g., based on the wife's mobile device being near/proximate to the computing device for outputting content), a second group of content items and types of content may be watched, reviewed, or searched and one or more devices 140 may be set at a second set of device settings. The system 100 may determine that when the husband and wife are together watching the display device 121 (e.g., based on the husband's and wife's mobile devices being near/proximate to the computing device for outputting content, such as the media device 120 and/or display device 121), a third group of content items and types of content may be watched, reviewed, or searched and one or more devices 140 may be set at a third set of device settings. The system 100 may determine that when the husband and a friend are together watching the display device 121 (e.g., based on the husband's and the friend's mobile devices being near/proximate to the computing device for outputting content), a fourth group of content items and types of content may be watched, reviewed, or searched and one or more devices 140 may be set at a fourth set of device settings. As such, different profiles for each situation (husband alone, wife alone, husband and wife together, husband and friend together) may have different viewing history and different device setting histories and, as such, recommendations for content items, and settings for devices 140 may be different depending on the specific group of users determined (based on mobile device location) to be watching the display device 121.

At 540, an output of content or a content recommendation may be caused. For example, the output of the content or content recommendation may be caused by a computing device, such as the application server 126, the central location 101, or the media device 120. For example, the output of content may be caused at the display device 121. For example, the content discovery system 152 of the application server 126 may evaluate the profile determined to include the identifiers for the mobile devices (e.g., mobile devices 124a, 124b) determined to be near/proximate to the computing device for outputting content, such as the media device 120 and/or display device 121. For example, the content discovery system 152 may evaluate the viewing history and/or search history for content items indicated in the profile and may determine content or content recommendations, (e.g., a set of recommended content items, advertisements, previews, and the like) to be sent to the computing device for outputting content, such as the media device 120 and display device 121, for presentation to the one or group of users 125a-b. For example, the content discovery system 152 may also evaluate the device setting history of the profile to determine one or more settings for the one or more devices 140 when the one or group of mobile devices (e.g., mobile devices 124a-b) are determined to be near/proximate to the computing device for outputting content. For example, based on the device setting history, the content discovery system 152 may determine one or more device settings for one or more devices 140 to change for presentation to the one or a group of users 125a-b.

The application server 126 may send the content. For example, the content may include the one or more recommended content items, advertisements, or previews determined based on the identified profile. For example, the content may include a recommendation of the one or more device settings for one or more devices 140 to change based on the determined mobile devices near/proximate to the computing device for outputting content, such as the media device 120 and/or display device 121. The content may be sent to the media device 120 and/or the display device 121. For example, the content may be sent to the media device 120 and the media device 120 may prepare and/or forward the content for display at the display device 121. For example, the content comprising the one or more recommended content items and the recommended device settings may also be sent to the one or more mobile devices 124a-b associated with the determined profile via the network 116 or another network.

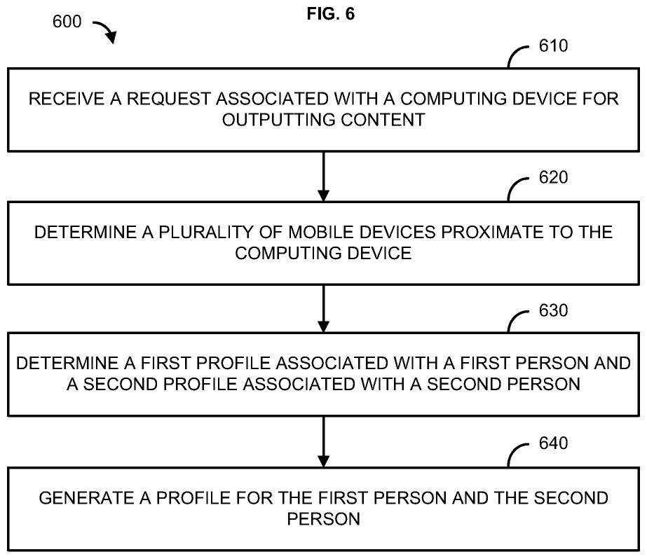

FIG. 6 shows a flowchart of an example method 600 for determining or generating a profile associated with a plurality of users. For example, the method 600 may be completed by a computing device, such as the application server 126, the central location 101, or the media device 120. At 610, a request associated with a display device (e.g., the display device 121) may be received. For example, the request may be sent by the computing device for outputting content (e.g., the media device 120 or the display device 121). For example, the request may be received by the application server 126 or another computing device. For example, the request may be received by the content discovery system 152 of the application server 126. The request may be for content items or recommendations of content items to be sent to the computing device for outputting content and caused to be displayed at the display device 121. For example, the request may be a request for what content items to recommend, offer, or display on the display device 121, a request to browse content items, a request to search content items, etc.

For example, the request may be based on a signal received by the computing device for outputting content, such as the display device 121 or the media device 120. For example, the signal may be based on a direct input at the computing device for outputting content via an input device, such as a keyboard or mouse, or from a wireless or wired remote control 404. For example, the signal may be received by the display device 121 and forwarded to the media device 120 via a wired or wireless communication, or may be directly received by the media device 120. The signal may be an activation signal to turn on the display device 121 and/or media device 120. The signal may be a request for content items to be received by the computing device for outputting content (e.g., the media device 120 or display device 121) for output at the display device 121. For example, the signal may be a request for any type of content or information that may be received by the computing device for outputting content for output at the display device 121, such as audio content, video content, audio/video content, streaming content, website content, image content, or the like. For example, the signal may be to search for and/or receive recommendations for one or more content items.

For example, the request may include a device identifier identifying the computing device for outputting content, such as the media device 120 and/or display device 121, making the request. For example, the device identifier may be a MAC address, device name, device number, user account number, user name or the like associated with the computing device for outputting content. For example, the request may include signal level data for the computing device for outputting content, such as the media device 120 and/or display device 121. For example, the signal level data may include the SNR for the computing device for outputting content, the RSSI for the computing device for outputting content, and/or the antenna of the network device (e.g., the access point 123) that receives the signals from the computing device for outputting content. For example, the application server 126 may know a location of the computing device for outputting content (e.g., the media device 120 and/or display device 121) within the user location 119 and the expected SNR, RSSI, and/or antenna of the network device that would indicate a device is proximate to (e.g., near, in the same room, adjacent to, or within a particular distance of) the computing device for outputting content.

At 620, a plurality of mobile devices proximate to the computing device for outputting content (e.g., the media device 120 and/or the display device 121) may be determined. For example, the plurality of mobile devices proximate to the computing device for outputting content may be determined by a computing device, such as the application server 126, the central location 101, or the media device 120. For example, the application server 126 (e.g., the content discovery system 152) may determine the location associated with the received request (e.g., from the computing device for outputting content). For example, the application server 126 may determine that the received request came from the user location 119. The user location 119 may be a premises, such as a residence or business, or a portion thereof. The application server 126 may determine one or more network devices (e.g., access points 123) located at the user location 119. For example, a network address for the network devices associated with and/or co-located with the computing device for outputting content (e.g., the media device 120 and/or display device 121) that sent the request may be stored in a profile in the profile management system 154. For example, the application server 126 may determine the one or more network devices (e.g., access point 123) to use based on the identifier of the computing device for outputting content in the received request.

For example, a request for wireless communication device data may be sent by the application server 126 and received by the network device (e.g., the access point 123) via the network 116 or another network. For example, the request may be sent based on a determination that the request for content was received from a location (e.g., the user location 119) associated with the access point 123. For example, the request for wireless communication device data may be a request for an indication of the wireless communication devices (e.g., stationary wireless communication devices and mobile devices) communicating with the access point 123. For example, the request may be sent to multiple access points within the user location 119.

The one or more network devices (e.g., access points 123) at the user location 119 receiving the request may identify the wireless communication devices (e.g., the stationary wireless devices such as device 140, the media device 120, the display device 121, the thermostat 406, one or more receptacles 408, one or more switches 410, one or more luminaires 412a-d, a fan, a smart speaker 414, a security system, or the like) and the mobile devices (e.g., non-stationary devices such as the mobile devices 124a-c)) within communication range of the particular access point 123.

For example, the application server 126 or the one or more network devices (e.g., access points 123) may be configured to determine if a device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

For example, the one or more wireless communication devices (e.g., the stationary wireless devices and the mobile devices) may send a response to the network device (e.g., the access point 123) that includes an indication of the wireless communication device that sent the response. For example, the indication may be an identifier of the wireless communication device sending the response. For example, the identifier of the wireless communication device may be the MAC address for the device, another unique identifier of the device, a URL associated with the device, a user name associated with the device, or an account identifier associated with the device. For each response received from each wireless communication device, the particular access point 123 may determine signal level data associated with the response, such as which antenna of the access point 123 received the response, the SNR of the response, the RSSI of the response, or other similar signal data.

The application server 126 may receive a response to the request for the wireless communication device data, via the network 116 or another network, from the one or more network devices (e.g., access points 123) of the user location 119. For example, the response to the request for the wireless communication device data may be received by the device diagnostic engine 151 of the application server 126. For example, the response may comprise a plurality of responses, each associated with one of the wireless communication devices communicating with the particular access point 123. Each response may include the indication of the one or more wireless communication devices communicating with the access point 123 and the signal level data associated with that particular wireless communication device.

The application server 126 may determine the one or more mobile devices (e.g., mobile devices 124a-b, located proximate to the computing device for outputting content, such as the media device 120 and/or display device 121, from which the request was received or associated. For example, the Wi-Fi device manager 153 of the application server 126 may determine which of the wireless communication devices communicating with the access point are mobile devices (e.g., mobile devices 124a-c) or are not stationary wireless communication devices (e.g., the media device 120, display device 121, the one or more other devices 140, such as the thermostat 406, one or more receptacles 408, one or more switches 410, one or more luminaires 412a-d, a fan, a smart speaker 414, a security system, or the like, etc.). For example, the Wi-Fi device manager 153 may determine which of the wireless communication devices provided by the access point 123 have not moved for a threshold period of time (e.g., a day, a week, a month, etc.) and may classify these devices as stationary wireless communication devices.

The content discovery system 152 of the application server 126 may compare the signal level data received in the request from the computing device for outputting content (e.g., the media device 120 and/or the display device 121) and/or the known location of the computing device for outputting content to the signal level data for the one or more determined mobile devices (e.g., mobile devices 124a-c) connected at the access point(s) 123 at the user location 119 to determine which mobile devices 124a-c are near or proximate to the computing device for outputting content (and thus likely having an associated user watching the content on the display device 121) from which the request was received. For example, the content discovery system 152 may determine which mobile devices 124a-c have an RSSI and/or SNR that is within a predetermined threshold of the RSSI and/or SNR of the requesting device (e.g., the computing device for outputting content, such as the media device 120 or display device 121) or an RSSI and/or SNR within a predetermined threshold position value for the expected RSSI and/or expected SNR for the known position of the computing device for outputting content with respect to a particular access point 123 in the user location 119. For example, the threshold may be a particular value, amount, or percentage from which the RSSI and/or SNR may vary from the RSSI and/or SNR of the computing device for outputting content or the expected RSSI/expected SNR. For example, the content discovery system 152 may also determine which antenna of the access point 123 the signal was received from the computing device for outputting content and the mobile devices 124a-c to determine the location of the mobile devices 124a-c with respect to the computing device for outputting content (e.g., the media device 120 and/or display device 121) associated with the request 204. For example, the content discovery system 152 may not consider mobile devices, such as mobile device 124c, whose signal was received by a different antenna of the access point 123 as that of the computing device for outputting content, or the expected antenna based on a known location of the computing device for outputting content, to be proximate to the requesting device and thus the users, such as user 125c (see FIG. 4), associated with those mobile devices 124c are likely not watching the content on the display device 121. For example, the content discovery system 152 may not consider mobile devices, such as mobile device 124c, based on the RSSI value of the signal received from mobile device 124c. For example, the RSSI value for the signal received from mobile device 124c may not be within a threshold value of the RSSI value of the communication received from the computing device for outputting content, indicating the mobile device 124c is not proximate to the computing device for outputting content, and thus, the user associated with mobile device 124c is likely not watching the content on a display associated with the computing device for outputting content. For example, the content discovery system 152 may not consider mobile devices, such as mobile device 124c, based on the SNR value of the signal received from mobile device 124c. For example, the SNR value for the signal received from mobile device 124c may not be within a threshold value of the SNR value of the communication received from the computing device for outputting content, indicating the mobile device 124c is not proximate to the computing device for outputting content, and thus, the user associated with mobile device 124c is likely not watching the content on a display associated with the computing device for outputting content.

In situations where signals from a mobile device (e.g., mobile devices 124a-c) were received by multiple access points 123 within a location 119, the content discovery system 152 may triangulate the signal to determine the location of the mobile device with respect to the computing device for outputting content (e.g., the media device 120 and/or display device 121) to determine if the particular mobile device is within a threshold distance of the computing device for outputting content to be considered proximate or near thereto.

At 630, a first profile associated with a first person and a second profile associated with a second person may be determined. For example, the first profile and the second profile may be determined by a computing device, such as the application server 126, the central location 101, or the media device 120. For example, the first profile and the second profile may be determined based on a first mobile device 124a and a second mobile device 124b being determined to be near or proximate to the computing device for outputting content, such as the media device 120 and/or the display device 121. For example, the first profile and the second profile may be determined based on a profile for the combined first mobile device 124a (and associated user 125a) and the second mobile device 124b (and associated second user 125b) not yet existing. The example of determining two profiles in FIG. 6 is for example purposes only. If, for example, a profile does not yet exist for any group of mobile devices (e.g., any two or more mobile devices) determined to be near or proximate to the computing device for outputting content, the application server 126 may determine the individual profiles (e.g., individual user profiles) associated with each of the mobile devices determined to be near or proximate to the computing device for outputting content, such as the media device 120 and/or display device 121.

For example, one or more of the mobile devices 124a-c may be new or new to the network 116 wherein a profile may not exist for the mobile device (e.g., the mobile device is new or signals from the mobile device have not previously been identified or received) at the location 119 (e.g., received by the one or more access points 123 of the location 119). A guest profile or unknown user profile may be created or determined for the one or more mobile devices 124a-c for which a profile does not exist. For example, the one or more mobile devices 124a-c may belong to or be associated with one or more new users 125a-b (e.g. guests, new mobile device owners, new residents, and/or previously unknown/unidentified residents) for the location 119 or may belong to or be associated with a previous user (e.g. previously guest or resident) with a new mobile device or one not previously brought to the location 119 that the system has not yet determined is associated with the previous user and the associated profile of the previous user. For example, over time, the one or more mobile devices 119 may be determined to be associated with (e.g., owned or carried by) a particular user having a particular profile. Based upon the subsequent determination that the one or more mobile devices 119 are associated with a particular user having a profile, the one or more mobile devices 119 may be also associated with that profile and the information previously obtained and stored in the guest or unknown user profile, may be added to the profile of the particular user. The particular user may be a resident living at the location 119 or may be a guest of the location 119 and associated with a user living at another location. For example, the particular user may have recently purchased the mobile device and the system may have not previously known that the new mobile device should be associated with the profile of that particular user.

For example, the application server 126 may determine the first profile associated with the first person based on the identifier (e.g., MAC address, device identifier, device name, account number, etc.) of the first mobile devices 124a determined to be near or proximate to the computing device for outputting content, such as the media device 120 or display device 121. For example, the application server 126 may determine the first profile, from the profile management system 154 that includes a device identifier (e.g., that matches) associated with the first mobile device 124a. For example, the application server 126 may compare the device identifier of the first mobile device 124a to the device identifiers in the stored profiles to determine which profile has a matching device identifier of the first mobile device 124a, and is therefore associated with the first user 125a.

For example, the application server 126 may determine the second profile associated with the second person based on the identifier (e.g., MAC address, device identifier, device name, account number, etc.) of the second mobile devices 124b determined to be near or proximate to the computing device for outputting content, such as the media device 120 and/or display device 121. For example, the application server 126 may determine the second profile, from the profile management system 154 that includes a device identifier associated with (e.g., that matches) the device identifier for the second mobile device 124a. For example, the application server 126 may compare the device identifier of the second mobile device 124b to the device identifiers in the stored profiles to determine which profile has a matching device identifier of the second mobile device 124b, and is therefore associated with the second user 125b.

For example, the first user profile associated with the first mobile device 124a and the first person (e.g., the first user 125a) may include a user name for the first person, a user identifier for the first person (e.g., an account ID, phone number, address, a unique identifier), one or more mobile devices associated with the first person, one or more mobile device identifiers for those one or more mobile devices, user demographics (e.g., age, sex, race, national origin) of the first person, locations (e.g., user location 119) of the first person, viewing history or searches for the first person, device settings for one or more devices 140 associated with the first person (e.g., in locations where the first person has been), and the like.

For example, the second user profile associated with the second mobile device 124b and the second person (e.g., the second user 125b) may include a user name for the second person, a user identifier for the second person (e.g., an account ID, phone number, address, a unique identifier), one or more mobile devices associated with the second person, one or more mobile device identifiers for those one or more mobile devices, user demographics (e.g., age, sex, race, national origin) of the second person, locations (e.g., user location 119) of the second person, viewing history or searches for the second person, device settings for one or more devices 140 associated with the second person (e.g., in locations where the second person has been), and the like.

At 640, a single profile for the first person and the second person may be generated, created, or determined. For example, the profile may be generated, created, or determined by a computing device, such as the application server 126, the central location 101, or the media device 120. For example, the profile may be generated based on the first profile associated with the first person and the second profile associated with the second person. For example, the profile may be generated based on the request from the computing device and based on a determination that a profile did not yet exist for the combination of mobile devices determined to be near or proximate to the computing device for outputting content, such as the media device 120 and/or the display device 121. For example, the profile may be associated with one or more content preferences indicated in the first profile associated with the first user and the second profile associated with the second user. For example, the profile may comprise content preferences found in both the first profile associated with the first user and the second profile associated with the second user.

For example, the application server 126 may retrieve information from the first profile and the second profile for inclusion in the newly generated profile. For example, the single profile for the first person and the second person may include a user name for the first person and a user name for the second person, a user identifier for the first person and the second person (e.g., an account ID, phone number, address, a unique identifier), one or more mobile devices associated with the first person and one or more mobile devices associated with the second person, one or more mobile device identifiers for those one or more mobile devices associated with the first person or the second person, user demographics (e.g., age, sex, race, national origin) of the first person and the second person, locations (e.g., user location 119) of the first person and the second person, viewing history or searches for the first person and the second person, device settings for one or more devices 140 associated with the first person and the second person (e.g., in locations where the first person or second person have been), and the like. For example, when generating the combination of the first person and the second person (e.g., based on the mobile devices 124a-b), the initial viewing history may be content items or content genres (e.g., sports, movies, sitcoms, dramas, reality shows, etc.) that are included in each (e.g., matching in each) of the first profile associated with the first person and the second profile associated with the second person. Once a profile is created, determined, or generated for the particular combination of people, subsequent locations, viewer history, content searches, and device settings may be received and stored when the combination of people (based on the determined combination of mobile devices 124a-b is determined to be near/proximate to a requesting device (e.g., the computing device for outputting content, such as the media device 120 and/or display device 121) requesting or searching content.

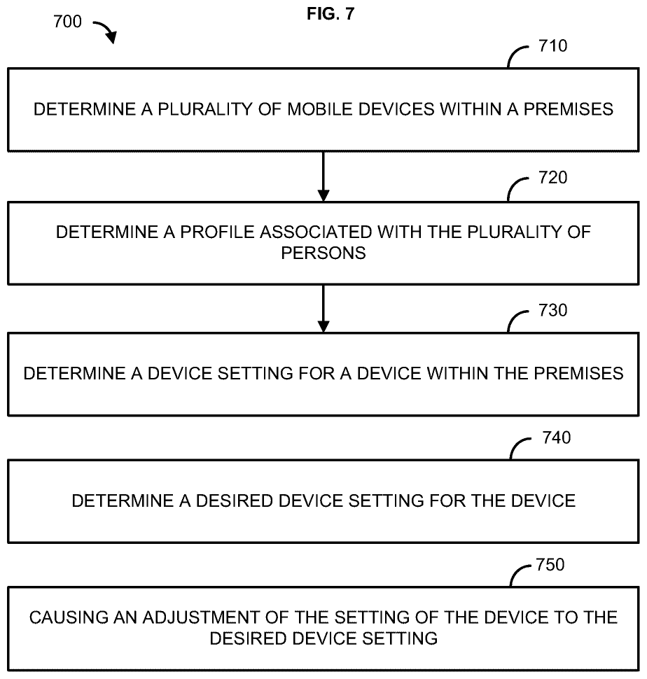

FIG. 7 shows a flowchart of an example method 700 for causing an adjustment of a setting of a device, such as a device 140. For example, the method 700 may be completed by a computing device, such as the application server 126, the central location 101, or the media device 120.

At 710, a plurality of mobile devices may be determined to be within a user location, such as a user location 119. For example, the user location 119 may be a premises, such as a residence. For example, the determination may be made by a computing device, such as the application server 126, the central location 101, or the media device 120. For example, one or more wireless communication devices (e.g., the stationary wireless devices, which may include the media device 120, the display device 121, or one or more devices 140, such as the thermostat 406, one or more receptacles 408, one or more switches 410, one or more luminaires 412a-d, a fan, a smart speaker 414, a security system, and/or the like, and the mobile devices, such as mobile devices 124a-c) may communicate with one or more network devices (e.g., the access points 123) of the user location 119. The communication from the wireless communication devices to the access point(s) 123 may be in the form of a response that may be sent based on a request from the access point(s) 123. One or more access points 123 at the user location 119 may receive the communication from each of the wireless communication devices. The communication may include an indication of the wireless communication device that sent the communication. For example, the indication may be an identifier of the wireless communication device sending the communication. For example, the identifier of the wireless communication device may be the MAC address for the device, another unique identifier of the device, a URL associated with the device, a user name associated with the device, or an account identifier associated with the device.

For each received communication from each wireless communication device, the particular access point 123 may determine signal level data associated with the communication. For example, the signal level data associated with the communication may include which antenna of the access point 123 received the communication, the SNR of the communication, the RSSI of the communication, or other similar signal data.

The access point 123 receiving the communication may send the information associated with the communication to the application server 126 via the network 116 or another network. For example, the information may be received by the device diagnostic engine 151 of the application server 126. For example, the information may comprise a plurality of communications, each associated with one of the wireless communication devices communicating with the particular access point 123. The information may include the indication of the one or more wireless communication devices communicating with the access point 123 and the signal level data associated with that particular wireless communication device.

The application server 126 may determine the plurality of mobile devices located at the user location 119, a particular portion of the user location 119 (e.g., a room or section) and/or proximate to the access point 123. For example, the Wi-Fi device manager 153 may determine which of the wireless communication devices communicating with the access point 123 are mobile devices (e.g., mobile devices 124a-c) or are not stationary wireless communication devices (e.g., the media device 120, display device 121, the one or more devices 140, etc. For example, the Wi-Fi device manager 153 or another portion of the application server 126 may determine which of the wireless communication devices indicated by the access point 123 have not moved for a threshold period of time (e.g., a day, a week, a month, etc.) and may classify these devices as stationary wireless communication devices.

For example, the application server 126 or the one or more network devices (e.g., access points 123) may be configured to determine if a device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

For example, the content discovery system 152 may compare the known location of the access point 123 within the user location 119 to the signal level data for the one or more determined mobile devices (e.g., mobile devices 124a-c) communicating with the access point(s) 123 at the user location 119 to determine which plurality of mobile devices 124a-c are at the user location 119, a particular portion of the user location 119 (e.g., a room or section) and/or proximate to the access point 123. For example, the content discovery system 152 may determine which mobile devices 124a-c have an RSSI and/or SNR within a predetermined threshold position value for the expected RSSI and/or expected SNR for a mobile device within the user location 119, a particular portion of the user location 119 (e.g., a room or section) and/or proximate to the access point 123. For example, the threshold may be a particular value, amount, or percentage from which the RSSI and/or SNR may vary from the expected RSSI/expected SNR. For example, the content discovery system 152 may also determine which antenna of the access point 123 the signal was received from the requesting device and the mobile devices 124a-c to determine the location of the mobile devices 124a-c with respect to the user location 119, a particular portion of the user location 119 (e.g., a room or section) and/or proximate to the access point 123.

In situations where communications from a mobile device (e.g., mobile devices 124a-c) were received by multiple access points 123 within a location 119, the content discovery system 152 may triangulate the signal to determine the location of the mobile device with respect to the user location 119, a particular portion of the user location 119 (e.g., a room or section) and/or the access point 123 to determine if the particular mobile device is within the user location 119, the particular part of the user location 119 and/or a threshold distance of the access point 123.

At 720, a profile associated with the plurality of mobile devices may be determined. For example, the plurality of mobile devices may be associated with a plurality of people within the user location 119. For example, the profile may be determined by a computing device, such as the application server 126, the central location 101, or the media device 120. For example, based on the identifiers (e.g., MAC address, device identifier, device name, account number, etc.) of the mobile devices 124a-c determined to be at the user location 119, a particular portion of the user location 119 (e.g., a room or section) and/or proximate to the access point 123, the content discovery system 152 may determine a profile, from the profile management system 154, that is based on or associated with (e.g., matches) the combination of people associated with the mobile devices determined to be at the user location 119, a particular portion of the user location 119 (e.g., a room or section) and/or proximate to the access point 123. For example, if mobile devices 124a and 124b are determined to be near or proximate to the access point 123 (or within the user location 119 or a particular portion of the user location 119), the content discovery system 152 will look for a profile that is based on or associated with (e.g., includes identifiers of) both the person 125a associated with mobile device 124a and the person 125b associated with mobile device 124b, and no additional devices or other users. For example, to identify a profile associated with the plurality of people, the content discovery system 152 may look for a profile that has mobile device identifiers that match the mobile device identifiers (e.g., MAC address, device identifier, device name, account number, etc.) for the mobile devices 124a and 124b. In certain examples, a particular person or name may not be yet associated with a profile that is associated with a mobile device identifier of a mobile device. That is, there may be situations where the mobile device is detected and one or more profiles that include the mobile device identifier for the particular mobile device (e.g., alone and in combination with one or more other mobile devices) before a particular user is identified as being associated with the particular mobile device. Still the mobile device will be considered to be associated with a person.

For example, a husband and wife may be living at a user location 119. The husband may have a first mobile device and the wife may have a second mobile device. The system 100 may determine that when the husband is alone in the user location 119 or a portion of the user location 119, one or more devices 140 may be set at a first set of device settings. Similarly, the system 100 may determine that when the wife is alone is alone in the user location 119 or a portion of the user location 119, one or more devices 140 may be set at a second set of device settings. The system 100 may determine that when the husband and wife are together in the user location 119 or a portion of the user location 119, one or more devices 140 may be set at a third set of device settings. The system 100 may determine that when the husband and a friend are together in the user location 119 or a portion of the user location 119, one or more devices 140 may be set at a fourth set of device settings. As such, different profiles for each situation (husband alone, wife alone, husband and wife together, husband and friend together) may have different device setting histories and, as such, recommendations for settings for devices 140 may be different depending on the specific group of users determined (based on mobile device location) to be at the user location 119 or a specific portion of the user location 119.

At 730, a current setting for one or more of the devices may be determined. For example, a computing device, such as the computing device for outputting content may determine the current setting for the one or more devices. For example, the computing device for outputting content may be the media device 120 or the display device 121. For example, the current setting for the one or more devices may be a current temperature setting at the thermostat 406, a current operational setting at the one or more receptacles 408, a current operational setting at the one or more switches 410, a current operational setting or light output level for one or more of the one or more luminaires 412a-d, a current operational setting or speed level for a fan, a current operational level or volume level for a smart speaker 414, or a current operational level for a security system.

At 740, a desired device setting for the one or more devices may be determined. For example, the desired device setting may be determined based on the profile associated with the plurality of persons. For example, the desired device setting may be determined by the application server 126, the central location 101, of the computing device for outputting content, such as the media device 120 or the display device 121. For example, the desired device setting may have been stored or uploaded by a person of the plurality of persons to the profile for the plurality of persons or determined based on one or more historical device settings for the particular device when the plurality of persons were at the location 119 or within a particular room or area of the location 119.

For example, the content discovery system 152 of the application server 126 may evaluate the profile determined to include the identifiers for the plurality of mobile devices (e.g., mobile devices 124a, 124b) determined to be at the user location 119, a particular portion of the user location 119, proximate the computing device for outputting content, and/or proximate the access point 123. For example, the content discovery system 152 may evaluate the device setting history of the profile to determine one or more desired device settings for the one or more devices 140 when the plurality of mobile devices associated with the particular profile are determined to be at the user location 119, a particular portion of the user location 119, proximate the computing device for outputting content, and/or proximate the access point 123. For example, based on the device setting history, the content discovery system 152 may determine one or more desired device settings for one or more devices 140 to change the one or more devices 140.

For example, the desired device setting for the one or more devices may comprise one or more of a desired temperature setting at the thermostat 406, a desired operational setting at the one or more receptacles 408, a desired operational setting at the one or more switches 410, a desired operational setting or light output level for one or more of the one or more luminaires 412a-d, a desired operational setting or speed level for a fan, a desired operational level or volume level for a smart speaker 414, or a current operational level for a security system. The desired device settings may further be determined based on the time of day, the day of the week, the current season, the current ambient temperature at the location 119, and/or the current content being displayed on the display 121.

At 750, the setting of one or more devices may be caused to be adjusted to the desired device setting for that particular device. For example, a computing device, such as the application server 126, the central location 101, or the computing device for outputting content (e.g., the media device 120 or the display device 121) may cause the setting of one or more devices, such as one or more of the devices 140, to be adjusted from the current device setting to the desired device setting.

To cause an adjustment in the setting of one or more devices 140, the application server 126 may send a response to the access point 123 for presentment at one or more of the plurality of mobile devices 124a-c. The response may include a recommendation of the one or more device settings for one or more devices 140 to change based on the determined mobile devices near/proximate to the computing device for outputting content, such as the media device 120 and/or display device 121. For example, the response may include instructions or embedded requests to change one or more device settings for one or more devices 140 based on the determined mobile devices at the user location 119, a particular portion of the user location 119, and/or proximate the access point 123 from the current device setting to the desired device setting.

For example, the access point 123 may receive the response. The access point 123 may wirelessly transmit instructions to the one or more devices 140 to change a device setting associated with that particular device 140 from the current device setting to the desired device setting. The mobile device 124a may receive the one or more desired device setting recommendations from the access point 123. The mobile device 124a may receive an input or selection indicating a selected desired device setting by the user 125a for one or more devices 140. The mobile device 124 may send the indicator or instruction to change the one or more current device settings for one or more devices 140 to the access point 123 or directly to the particular device 140.

To cause an adjustment of the current setting of one or more devices 140, the application server 126 may send one or more instructions to the access point 123. The one or more instructions may include one or more instructions to change the one or more current device settings for one or more devices 140 to the desired device setting for that particular device 140. The access point 123 may receive the one or more instructions and may send the one or more instructions to one or more devices 140 to change a current device setting of that particular device 140 to a desired device setting for that particular device 140. For example, the instructions may include an instruction to change the temperature on the thermostat 406, to turn on/off the one or more luminaires (e.g., lights) 412a-d, to adjust the light level of the one or more luminaires 412a-d, to change a setting on the fan, to change a setting on the smart appliance, to change the setting on the security system for the location 119, to change the audio level on the smart speaker 414, to activate/deactivate the one or more switches 410 or electrical receptacles 408 or change one or more other device settings on another device 140. The device setting for a particular device 140 may change in response to the device 140 receiving the instruction and initiating the change in the device setting.

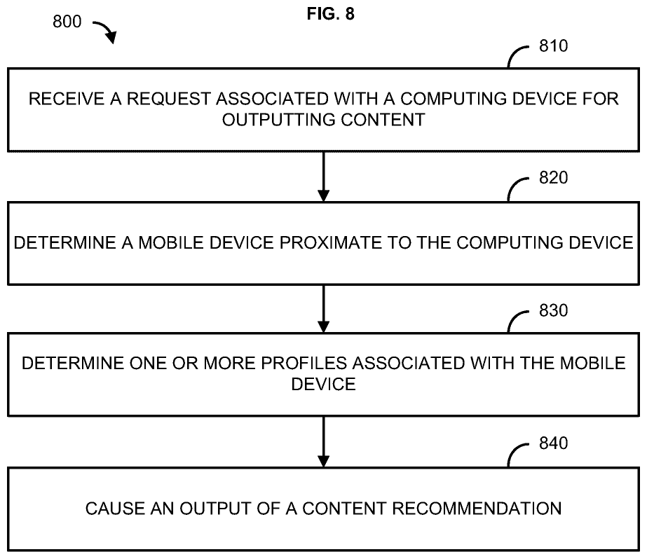

FIG. 8 shows a flowchart of an example method 800 for determining a profile associated with a user viewing content. For example, the method 800 may be completed by a computing device, such as the application server 126, the central location 101, or the media device 120. At 810, a request associated with a computing device for outputting content may be received. For example, the request may be received by the application server 126 from the computing device for outputting content, such as the media device 120 or the display device 121. For example, the request may be received by the content discovery system 152 of the application server 126. The request may be for content items or suggested content item recommendations to be received by the computing device for outputting content and caused to be displayed at the display device 121. For example, the request may be a request for what content items to offer, recommend, or display on the display device 121, a request to browse content items, a request to search content items, etc.

For example, the request may be based on a signal received by the computing device for outputting content, such as the display device 121 or the media device 120. For example, the signal may be based on a direct input at the computing device for outputting content via an input device, such as a keyboard or mouse, or from a wireless or wired remote control 404. For example, the signal may be received by the display device 121 and forwarded to the media device 120 via a wired or wireless communication, or may be directly received by the media device 120. The signal may be an activation signal to turn on the display device 121 and/or media device 120. The signal may be a request for content items to be received by the computing device for outputting content (e.g., the media device 120 or display device 121) for output at the display device 121. For example, the signal may be a request for any type of content or information that may be received by the computing device for outputting content for output at the display device 121, such as audio content, video content, audio/video content, streaming content, website content, image content, or the like. For example, the signal may be to search for and/or receive recommendations for one or more content items.

For example, the request may include a device identifier identifying the computing device for outputting content (e.g., the media device 120 or display device 121) making the request. For example, the device identifier may be a MAC address, device name, device number, user account number, user name or the like. For example, the request may include signal level data for the computing device for outputting content. For example, the signal level data may include the SNR for the computing device for outputting content (e.g., the media device 120 and/or the display device 121), the RSSI for the computing device for outputting content, and/or the antenna of the network device (e.g., the access point 123) that receives the signals from the computing device for outputting content. For example, the application server 126 may know a location of the computing device for outputting content within the user location 119 and the SNR, RSSI, and/or antenna of the network device that would indicate a device is proximate to (e.g., near, in the same room, adjacent to, or within a particular distance of) the computing device for outputting content, such as the media device 120 and/or display device 121.

At 820, a mobile device proximate to the computing device for outputting content may be determined. For example, the mobile device proximate to the computing device for outputting content may be determined by a computing device, such as the application server 126, the central location 101, or the media device 120. For example, the application server 126 (e.g., the content discovery system 152) may determine the location associated with the received request from the computing device for outputting content. For example, the application server 126 may determine that the received request came from the user location 119. The application server 126 may determine one or more network devices (e.g., access points 123) located at the user location 119. For example, a network address for the network devices associated with and/or co-located with the computing device for outputting content, such as the media device 120 and/or display device 121, that sent the request may be stored in a profile in the profile management system 154. For example, the application server 126 may determine the one or more network devices (e.g., access points 123) to use based on the identifier of the computing device for outputting content (e.g., the media device 120 or display device 121) in the received request.

For example, a request may be sent by the application server 126 and received by the network device (e.g., the access point 123) via the network 116 or another network. For example, the request may be sent based on a determination that the request was received from a location (e.g., the user location 119) associated with the access point 123. For example, the request may be a request for an indication of the wireless communication devices (e.g., stationary wireless communication devices and mobile devices) communicating with the access point 123. For example, the request may be sent to multiple access points within the user location 119.

The one or more network devices (e.g., access points 123) at the user location 119 receiving the request may identify the wireless communication devices (e.g., the stationary wireless devices such as device 140, the media device 120, the display device 121, the thermostat 406, one or more receptacles 408, one or more switches 410, one or more luminaires 412a-d, a fan, a smart speaker 414, a security system, or the like) and the mobile devices (e.g., the mobile devices 124a-c)) within communication range of the particular access point 123. For example, the one or more wireless communication devices (e.g., the stationary wireless devices and the mobile devices) may send a response to the network device (e.g., the access point 123) that includes an indication of the wireless communication device that sent the response. For example, the indication may be an identifier of the wireless communication device sending the response. For example, the identifier of the wireless communication device may be the MAC address for the device, another unique identifier of the device, a URL associated with the device, a user name associated with the device, or an account identifier associated with the device. For each response received from each wireless communication device, the particular access point 123 may determine signal level data associated with the response, such as which antenna of the access point 123 received the response, the SNR of the response, the RSSI of the response, or other similar signal data.

The application server 126 may receive a response, via the network 116 or another network, from the one or more network devices (e.g., access points 123) of the user location 119. For example, the response may be received by the device diagnostic engine 151 of the application server 126. For example, the response may comprise a plurality of responses, each associated with one of the wireless communication devices communicating with the particular access point 123. Each response may include the indication of the one or more wireless communication devices communicating with the access point 123 and the signal level data associated with that particular wireless communication device.

For example, the application server 126 or the one or more network devices (e.g., access points 123) may be configured to determine if a wireless communication device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

For example, the application server 126 may determine the mobile device (e.g., mobile devices 124a, located proximate to or closest to the computing device for outputting content (e.g., the media device 120 and/or display device 121) from which the request was received or associated. For example, the Wi-Fi device manager 153 of the application server 126 may determine which of the wireless communication devices communicating with the access point 123 are mobile devices (e.g., mobile devices 124a-c) or are not stationary wireless communication devices. For example, the Wi-Fi device manager 153 may determine which of the wireless communication devices provided by the access point 123 have not moved for a threshold period of time (e.g., a day, a week, a month, etc.) and may classify these devices as stationary wireless communication devices.

The content discovery system 152 of the application server 126 may compare the signal level data received in the request from the computing device for outputting content and/or the known location of the computing device for outputting content (e.g., the display device 121 and/or media device 120) to the signal level data for the one or more determined mobile devices (e.g., mobile devices 124a-c) connected at the access point(s) 123 at the user location 119 to determine which mobile device 124a-c is near or proximate or closest to the computing device for outputting content (and thus likely having an associated user watching the content on the display device 121) from which the request was received. For example, the content discovery system 152 may determine which mobile device 124a-c has an RSSI and/or SNR that is within a predetermined threshold of the RSSI and/or SNR of the requesting device (e.g., the computing device for outputting content, such as the media device 120 or display device 121) or an RSSI and/or SNR within a predetermined threshold position value for the expected RSSI and/or expected SNR for the known position of the computing device for outputting content with respect to a particular access point 123 in the user location 119. For example, the threshold may be a particular value, amount, or percentage from which the RSSI and/or SNR may vary from the RSSI and/or SNR of the computing device for outputting content or the expected RSSI/expected SNR. For example, the content discovery system 152 may also determine which antenna of the access point 123 the signal was received from the computing device for outputting content and the mobile devices 124a-c to determine the location of the mobile devices 124a-c with respect to the computing device for outputting content (e.g., the media device 120 and/or display device 121) associated with the request 204. For example, the content discovery system 152 may not consider mobile devices, such as mobile device 124c, whose signal was received by a different antenna of the access point 123 as that of the media device 120 and/or display device 121, or the expected antenna based on a known location of the computing device for outputting content, to be proximate to the computing device for outputting content and thus the users, such as user 125c (see FIG. 4), associated with those mobile devices 124c are likely not watching the content on the display device 121. For example, the content discovery system 152 may not consider mobile devices, such as mobile device 124c, based on the RSSI value of the signal received from mobile device 124c. For example, the RSSI value for the signal received from mobile device 124c may not be within a threshold value of the RSSI value of the communication received from the computing device for outputting content, indicating the mobile device 124c is not proximate to the computing device for outputting content, and thus, the user associated with mobile device 124c is likely not watching the content on a display associated with the computing device for outputting content. For example, the content discovery system 152 may not consider mobile devices, such as mobile device 124c, based on the SNR value of the signal received from mobile device 124c. For example, the SNR value for the signal received from mobile device 124c may not be within a threshold value of the SNR value of the communication received from the computing device for outputting content, indicating the mobile device 124c is not proximate to the computing device for outputting content, and thus, the user associated with mobile device 124c is likely not watching the content on a display associated with the computing device for outputting content.

In situations where signals from a mobile device (e.g., mobile devices 124a-c) were received by multiple access points 123 within a location 119, the content discovery system 152 may triangulate the signal to determine the location of the mobile device with respect to the computing device for outputting content (e.g., the media device 120 and/or display device 121) to determine if the particular mobile device is within a threshold distance of or closest to the computing device for outputting content to be considered proximate or near thereto.

At 830, one or more profiles, associated with the determined mobile device that is proximate to or closest to the computing device for outputting content, may be determined. For example, the profile may be determined by a computing device, such as the application server 126, the central location 101, or the media device 120. For example, the application server 126 may determine a profile based on the identifier (e.g., MAC address, device identifier, device name, account number, etc.) of the mobile device 124a-c determined to be proximate to or closest to the computing device for outputting content, such as the media device 120 or display device 121. For example, the application server 126 may determine a profile, from the profile management system 154, that is based on or associated with (e.g., matches) the user associated with the mobile device determined to be proximate to or closest to the computing device for outputting content. For example, if mobile device 124a (see FIG. 4) is determined to be proximate to or closest to the computing device for outputting content, the content discovery system 152 will look for a profile that is based on or associated with (e.g., includes) the user associated with mobile device 124a, and no additional devices or users. For example, the content discovery system 152 may look for a profile that has a mobile device identifier that matches the mobile device identifier (e.g., MAC address, device identifier, device name, account number, etc.) for the mobile device 124a.

For example, the profile associated with the first user 125a and the mobile device 124a may include data such as user names, user identifiers (e.g., an account ID, phone number, address, a unique identifier), mobile devices associated with the particular user name, user demographics (e.g., age, sex, race, national origin), locations (e.g., user location 119) of the user, viewing history or searches for the particular user, device settings for one or more devices associated with the particular user (e.g., in locations where the user has been), and the like. Once the profile is determined, any selections made at the computing device for outputting content (e.g., the media device 120 or display device 121) that the mobile device 124a is closest to may be stored as updates to the viewing history or content searches of that profile.

At 840, an output of content or a content recommendation may be caused. For example, the output of the content or content recommendation may be caused by a computing device, such as the application server 126, the central location 101, or the media device 120. For example, the output of content may be caused at the display device 121. For example, the content discovery system 152 of the application server 126 may evaluate the profile determined to include the identifier for the mobile device (e.g., mobile device 124a) determined to be near/proximate or closest to the computing device for outputting content, such as the media device 120 and/or display device 121. For example, the content discovery system 152 may evaluate the viewing history and/or search history for content items indicated in the profile and may determine content, (e.g., a set of recommended content items, advertisements, previews, and the like) to be sent to the computing device for outputting content, such as the media device 120 and display device 121, for presentation to the one or group of users 125a-b. For example, the content discovery system 152 may also evaluate the device setting history of the profile to determine one or more settings for the one or more devices 140 when the mobile devices 124a is determined to be near/proximate or closest to the computing device for outputting content, such as the media device 120 and/or display device 121. For example, based on the device setting history, the content discovery system 152 may determine one or more device settings for one or more devices 140 to change for presentation to the user 125a.

The application server 126 may send the content. For example, the content may include the one or more recommended content items, advertisements, or previews determined based on the identified profile. For example, the content may include a recommendation of the one or more device settings for one or more devices 140 to change based on the determined mobile device near/proximate or closest to the computing device for outputting content, such as the media device 120 and/or display device 121. The content may be sent to the media device 120 and/or the display device 121. For example, the content may be sent to the media device 120 and the media device 120 may prepare and/or forward the content for display at the display device 121. For example, the content comprising the one or more recommended content items and the recommended device settings may also be sent to the mobile device 124a associated with the determined profile via the network 116 or another network.

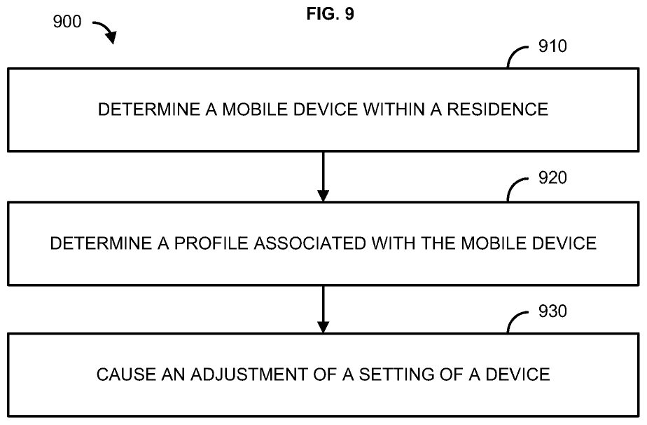

FIG. 9 shows a flowchart of an example method 900 for causing an adjustment of a setting of a device, such as a device 140. For example, the method 900 may be completed by a computing device, such as the application server 126, the central location 101, or the media device 120.

At 910, a mobile device may be determined to be within a user location, such as a user location 119. For example, the user location 119 may be a premises, such as a residence. For example, the determination may be made by a computing device, such as the application server 126, the central location 101, or the media device 120. For example, one or more wireless communication devices (e.g., the stationary wireless devices, which may include the media device 120, the display device 121, or one or more devices 140, such as the thermostat 406, one or more receptacles 408, one or more switches 410, one or more luminaires 412a-d, a fan, a smart speaker 414, a security system, and/or the like, and the mobile devices, such as mobile devices 124a) may communicate with one or more network devices (e.g., the access points 123) of the user location 119. The communication from the wireless communication devices to the access point(s) 123 may be in the form of a response that may be sent based on a request from the access point(s) 123. One or more access points 123 at the user location 119 may receive the communication from each of the wireless communication devices. The communication may include an indication of the wireless communication device that sent the communication. For example, the indication may be an identifier of the wireless communication device sending the communication. For example, the identifier of the wireless communication device may be the MAC address for the device, another unique identifier of the device, a URL associated with the device, a user name associated with the device, or an account identifier associated with the device. For each received communication from each wireless communication device, the particular access point 123 may determine signal level data associated with the communication. For example, the signal level data associated with the communication may include which antenna of the access point 123 received the communication, the SNR of the communication, the RSSI of the communication, or other similar signal data.

The access point 123 receiving the communication may send the information associated with the communication to the application server 126 via the network 116 or another network. For example, the information may be received by the device diagnostic engine 151 of the application server 126. For example, the information may comprise a plurality of communications, each associated with one of the wireless communication devices communicating with the particular access point 123. The information may include the indication of the one or more wireless communication devices communicating with the access point 123 and the signal level data associated with that particular wireless communication device.

The application server 126 may determine a mobile device located at the user location 119, a particular portion of the user location 119 (e.g., a room or section) and/or proximate to the access point 123. For example, the Wi-Fi device manager 153 may determine which of the wireless communication devices communicating with the access point 123 are mobile devices (e.g., mobile device 124a) or are stationary wireless communication devices (e.g., the media device 120, display device 121, the one or more devices 140, etc. For example, the Wi-Fi device manager 153 or another portion of the application server 126 may determine which of the wireless communication devices indicated by the access point 123 have not moved for a threshold period of time (e.g., a day, a week, a month, etc.) and may classify these devices as stationary wireless communication devices.

For example, the application server 126 or the one or more network devices (e.g., access points 123) may be configured to determine if a device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

For example, the content discovery system 152 may compare the known location of the access point 123 within the user location 119 to the signal level data for the one or more determined mobile devices (e.g., mobile devices 124a-c) communicating with the access point(s) 123 at the user location 119 to determine which mobile devices 124a-c are at the user location 119, a particular portion of the user location 119 (e.g., a room or section) and/or proximate to the access point 123. For example, the content discovery system 152 may determine which mobile device 124a has an RSSI and/or SNR within a predetermined threshold position value for the expected RSSI and/or expected SNR for a mobile device within the user location 119, a particular portion of the user location 119 (e.g., a room or section) and/or proximate to the access point 123. For example, the threshold may be a particular value, amount, or percentage from which the RSSI and/or SNR may vary from the expected RSSI/expected SNR. For example, the content discovery system 152 may also determine which antenna of the access point 123 the signal was received from the requesting device and the mobile devices 124a-c to determine the location of the mobile device 124a with respect to the user location 119, a particular portion of the user location 119 (e.g., a room or section) and/or proximate to the access point 123.

In situations where communications from a mobile device 124a was received by multiple access points 123 within a location 119, the content discovery system 152 may triangulate the signal to determine the location of the mobile device 124a with respect to the user location 119, a particular portion of the user location 119 (e.g., a room or section) and/or the access point 123 to determine if the particular mobile device is within the user location 119, the particular part of the user location 119 and/or a threshold distance of the access point 123.

At 920, a profile associated with the mobile device 124a may be determined. For example, the mobile device 124a may be associated with a person 125a within the user location 119. For example, the profile may be determined by a computing device, such as the application server 126, the central location 101, or the media device 120. For example, based on the identifier (e.g., MAC address, device identifier, device name, account number, etc.) of the mobile device 124a determined to be at the user location 119, a particular portion of the user location 119 (e.g., a room or section) and/or proximate to the access point 123, the content discovery system 152 may determine a profile, from the profile management system 154, that is based on or associated with (e.g., matches) the person 125a associated with the mobile device 124a determined to be at the user location 119, a particular portion of the user location 119 (e.g., a room or section) and/or proximate to the access point 123. For example, to identify a profile associated with the person 125a, the content discovery system 152 may look for a profile that has a mobile device identifier that matches the mobile device identifier (e.g., MAC address, device identifier, device name, account number, etc.) for the mobile device 124a. In certain examples, a particular person or name may not be yet associated with a profile that is associated with a mobile device identifier of a mobile device. That is, there may be situations where the mobile device is detected and one or more profiles that include the mobile device identifier for the particular mobile device (e.g., alone and in combination with one or more other mobile devices) before a particular user is identified as being associated with the particular mobile device. Still the mobile device will be considered to be associated with a person.

At 930, a setting of one or more devices may be adjusted. For example, a computing device, such as the application server 126, the central location 101, or the media device 120 may cause the setting of one or more devices, such as devices 140, to be adjusted.

For example, the content discovery system 152 of the application server 126 may evaluate the profile determined to include the identifier for the mobile device 124a determined to be at the user location 119, a particular portion of the user location 119, and/or proximate the access point 123. For example, the content discovery system 152 may evaluate the device setting history of the profile to determine one or more settings for the one or more devices 140 when the mobile device 124a is determined to be at the user location 119, a particular portion of the user location 119, and/or proximate the access point 123. For example, the settings may include any one or more of the device being turned on, the device being turned off, the device level, the temperature setting for the device, etc. For example, the device 140 may be any one of an IoT device, thermostat 406, one or more luminaires 412a-d, a smart speaker 414, a switch 410, an electrical receptacle 408, a fan, a smart appliance, a security system, or the like. For example, based on the device setting history, the content discovery system 152 may determine one or more device settings for one or more devices 140 to change the one or more devices 140.

To cause an adjustment in the setting of one or more devices 140, the application server 126 may send a response to the access point 123 for presentment at the mobile device 124a. The response may include a recommendation of the one or more device settings for one or more devices 140 to change based on the determined mobile device 124a near/proximate to the computing device for outputting content, such as the media device 120 and/or display device 121. For example, the response may include instructions or embedded requests to change one or more device settings for one or more devices 140 based on the determined mobile device 124a at the user location 119, a particular portion of the user location 119, and/or proximate the access point 123.

For example, the access point 123 may receive the response. The access point 123 may wirelessly transmit instructions to the one or more devices 140 to change a device setting associated with that particular device 140. The mobile device 124a may receive the one or more device setting recommendations from the access point 123. The mobile device 124a may receive an input or selection indicating a desire by the user 125a to change a device setting of one or more devices 140. The mobile device 124a may send the indicator or instruction to change the one or more device settings for one or more devices 140 to the access point 123 or directly to the device 140.

To cause an adjustment in the setting of one or more devices 140, the application server 126 may send one or more instructions to the access point 123. The one or more instructions may include one or more instructions to change the one or more device settings for one or more devices 140. The access point 123 may receive the one or more instructions and may send the one or more instructions to one or more devices 140 to change a device setting of that particular device 140. For example, the instructions may include an instruction to change the temperature on a thermostat 406, to turn on/off one or more luminaires (e.g., lights) 412a-d, to adjust the light level of one or more luminaires 412a-d, to change a setting on a fan, to change a setting on a smart appliance, to change a setting on a security system for the location 119, to change an audio level on a smart speaker 414, to activate/deactivate one or more switches 410 or electrical receptacles 408 or change one or more other device settings on another device 140. The device setting for a particular device 140 may change in response to the device 140 receiving the instruction and initiating the change in the device setting.

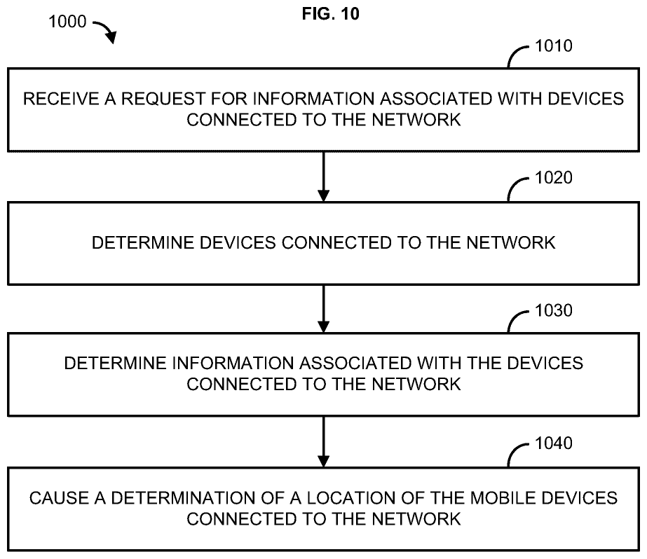

FIG. 10 shows a flowchart of an example method 1000 for determining the location of mobile devices (e.g., mobile devices 124a-c) connected to the network. For example, the method 1000 may be completed by a computing device, such as a network device, the access point 123.

At 1010, a request for information associated with devices connected to the network may be received. For example, the network may be the network 116 or another network. The request may be sent by the application server 126. For example, the request may be received by the network device (e.g., the access point 123). For example, the request may be sent based on a determination that another request was received by the application server 126 from a location (e.g., the user location 119) associated with the access point 123. For example, the information requested may include an indication of the wireless communication devices (e.g., stationary wireless communication devices and mobile devices) communicating with the access point 123.

At 1020, the one or more wireless communication devices connected to the network of the access point may be determined. For example, the one or more wireless communication devices may be determined by the access point 123. For example, the access point 123 may determine the wireless communication devices connected to the network based on receiving a communication from each of the wireless communication devices. For example, the access point 123 at the user location 119 may receive communications from one or more wireless communication devices (e.g., the stationary wireless devices such as device 140, the media device 120, the display device 121, the thermostat 406, one or more receptacles 408, one or more switches 410, one or more luminaires 412a-d, a fan, a smart speaker 414, a security system, or the like) and the mobile devices (e.g., the mobile devices 124a-c)) within communication range of the access point 123. For example, the communications may be received by the access point 123 based on a request sent out by the access point 123 to the one or more wireless communication devices.

At 1030, information associated with the wireless communication devices connected to the access point 123 and network 116 may be determined. For example, the information associated with the wireless communication devices may be determined by the access point 123. For example, the communication received by the access point 123 from each of the wireless communication devices may include an indication of the wireless communication device that sent the communication. For example, the information determined by the access point 123 may include this indication. For example, the indication may be an identifier of the wireless communication device sending the communication. For example, the identifier of the wireless communication device may be the MAC address for the device, another unique identifier of the device, a URL associated with the device, a user name associated with the device, or an account identifier associated with the device.

For each communication received from each wireless communication device, the access point 123 may determine signal level data associated with the communication. For example, the information determined by the access point 123 may include this signal level data. For example, the signal level data associated with the communication may include which antenna of the access point 123 received the communication, the SNR of the communication, the RSSI of the communication, or other similar signal data.

At 1040, a location of the mobile devices within the wireless communication devices communicating with the access point 123 may be determined. For example, the access point 123 may cause the determination of the location of the mobile device (e.g., mobile device 124a-c) by sending the information to a computing device, such as an application server 126 via the network 116 or another network.

For example, the information may be received by the device diagnostic engine 151 of the application server 126. For example, the information may comprise a plurality of communications, each associated with one of the wireless communication devices communicating with the access point 123. For example, the information sent to the application server 126 may include the indication of the one or more wireless communication devices communicating with the access point 123 and the signal level data associated with that particular wireless communication device for the communication from the particular wireless communication device.

For example, the application server 126 or the one or more network devices (e.g., access points 123) may be configured to determine if a wireless communication device will be considered a stationary wireless device or a mobile (or transient) device based on signal analysis of one or more signals transmitted by the one or more wireless communication devices of the system 100, 400. For example, mobile device 124a is a smart phone, mobile device 124b is a tablet computer, and media device 120 is a set-top box.

For example, when the smart phone 124a enters the premises, it may connect to the access point 123 at a first time. The smart phone 123 may be carried by a user, such as user 125a. As the user 125a moves about the user location or premises 119 (with the smart phone 124a), the smart phone 124a communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point 123, may change. For example, an RSSI value for the smart phone 124a at the access point(s) 123 may change (or change an amount that satisfies a threshold), a signal envelope (e.g., frequency characteristics) may change (or change an amount that satisfies a threshold), amplitude or phase data associated with the one or more signals sent between and received by the smart phone 124a and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the smart phone 124a is a mobile device and may include it in a group or bucket of mobile devices for the premises 119 and for other premises that the smart phone 124a subsequently moves to (based on a device identifier for the smart phone 124a, such as a MAC address or user ID). The application server 126 or the one or more network devices may determine, because the smart phone 124a is a mobile device, that the smart phone 124a may be associated with a profile or user and may be used to determine when the user or profile may be proximate to a display, based on the location of the smart phone 124a, and watching the content on the display.

For example, when the tablet computer 124b enters the premises, it may connect to the access point 123 at a first time. The tablet computer 124b may be carried by a user, such as user 125b. As the user 125a moves about the user location or premises 119 (with the tablet computer 124b), the tablet computer 124b communicates with the access point 123 (or another access point on the premises 119) at a second time, and then communicates to the access point 123 (or another access point on the premises 119) at a third time. Between the first time and the second time and/or the second time and the third time, one or more signal characteristics associated with one or more signals to the access point(s) 123, may change. For example, an RSSI value for the tablet computer 124b at the access point(s) 123 may change (or change an amount that satisfies a threshold), a signal envelope (e.g., frequency characteristics) may change (or change an amount that satisfies a threshold), amplitude or phase data associated with the one or more signals sent between and received by the tablet computer 124b and the access point(s) 123 may change (or change an amount that satisfies a threshold), combinations thereof, and the like. The application server 126 or the one or more network devices may analyze these changes and determine (e.g., make a determination based on the change alone or based on the amount of change satisfying a threshold) that the tablet computer 124b is a mobile device and may include it in a group or bucket of mobile devices for the premises 119 and for other premises that the tablet computer 124b subsequently moves to (based on a device identifier for the tablet computer 124b, such as a MAC address or user ID). The application server 126 or the one or more network devices may determine, because the tablet computer 124b is a mobile device, that the tablet computer 124b may be associated with a profile or user and may be used to determine when the user or profile may be proximate to a display, based on the location of the tablet computer 124b, and watching the content on the display.

For example, when the set-top box 120 is first placed within the premises, it may connect to the access point 123 at a first time. The set-top box 120 may not be moved and may stay in a single location for a period of time. The period of time may satisfy a stationary threshold (e.g., more than 1 day, 2 days, 1 week, etc.). The set-top box 120 may communicate with the access point 123 at a second time, and then communicate with the access point 123 at a third time. Between the first time and the second time and/or the second time and the third time, one or more signal characteristics associated with one or more signals to the access point 123, may not change (or the amount of change may not satisfy a threshold). For example, an RSSI value for the set-top box 120 at the access point 123 may not change (or not change an amount that satisfies a threshold), a signal envelope (e.g., frequency characteristics) may not change (or not change an amount that satisfies a threshold), amplitude or phase data associated with the one or more signals sent between and received by the set-top box 120 and the access point 123 may not change (or not change an amount that satisfies a threshold), combinations thereof, and the like. The application server 126 or the one or more network devices may analyze the lack of change and determine (e.g., make a determination based on the lack of change alone or based on the amount of change not satisfying a threshold) that the set-top box 120 is a stationary device and not a mobile or transient device and may include the set-top box 120 in a group or bucket of stationary devices for the premises 119 (based on a device identifier for the set-top box 120, such as a MAC address). The application server 126 or the one or more network devices may determine, because the set-top box 120 is a stationary device, that the set-top box 120 may not be used for evaluating the movement of users or profiles associated with the set-top box 120 and the content they are viewing.

The application server 126 may determine the one or more mobile devices (e.g., mobile devices 124a-c, located proximate to the computing device for outputting content, such as the media device 120 and/or display device 121, from which an initial request was received or associated. For example, the Wi-Fi device manager 153 may determine which of the wireless communication devices communicating with the access point are mobile devices (e.g., mobile devices 124a-c) or are not stationary wireless communication devices (e.g., the media device 120, display device 121, the one or more other devices 140, such as the thermostat 406, one or more receptacles 408, one or more switches 410, one or more luminaires 412a-d, a fan, a smart speaker 414, a security system, or the like, etc.

The application server 126 may compare the signal level data received in the initial request and/or the known location of the computing device for outputting content, such as the display device 121 and/or media device 120, to the signal level data for the one or more determined mobile devices (e.g., mobile devices 124a-c) connected at the access point(s) 123 at the user location 119 to determine which mobile devices 124a-c are near or proximate to the computing device for outputting content. For example, the application server 126 may determine which mobile devices 124a-c have an RSSI and/or SNR that is within a predetermined threshold of the RSSI and/or SNR of the requesting device (e.g., computing device for outputting content, such as the media device 120 or display device 121) or an RSSI and/or SNR within a predetermined threshold position value for the expected RSSI and/or expected SNR for the known position of the computing device for outputting content with respect to a particular access point 123 in the user location 119. For example, the threshold may be a particular value, amount, or percentage from which the RSSI and/or SNR may vary from the RSSI and/or SNR of the requesting device or the expected RSSI/expected SNR. For example, the application server 126 may also determine which antenna of the access point 123 the signal was received from the requesting device and the mobile devices 124a-c to determine the location of the mobile devices 124a-c with respect to the computing device for outputting content, such as the media device 120 and/or display device 121.

Based on the identifiers (e.g., MAC address, device identifier, device name, account number, etc.) of the mobile devices 124a-c determined to be near/proximate to the requesting device (e.g., the computing device for outputting content) the content discovery system 152 may determine a profile, from the profile management system 154, that is based on or associated with (e.g., matches) the one user or combination of users associated with the mobile devices determined to be proximate to the computing device for outputting content, such as the media device 120 and/or the display device 121. For example, the content discovery system 152 may look for a profile that has mobile device identifiers that match the mobile device identifiers (e.g., MAC address, device identifier, device name, account number, etc.) for the mobile devices 124a and 124b.

The content discovery system 152 may evaluate the profile determined to include the identifiers for the mobile devices (e.g., mobile devices 124a, 124b) determined to be near/proximate to the computing device for outputting content. For example, the content discovery system 152 may evaluate the viewing history and/or search history for content items indicated in the profile and may determine a set of recommended content items to be sent back to the computing device for outputting content, such as the media device 120 and display device 121 for presentation to the one or a group of users 125a-b. For example, the content discovery system 152 may evaluate the device setting history of the profile to determine one or more settings for the one or more devices 140 when the one or group of mobile devices (e.g., mobile devices 124a-b) are determined to be near/proximate to the computing device for outputting content. For example, based on the device setting history, the content discovery system 152 may determine one or more device settings for one or more devices 140 to change for presentation to the one or a group of users 125a-b.

The application server 126 may send content. For example, the content may include the one or more recommended content items determined based on the identified profile. For example, the content may include a recommendation of the one or more device settings for one or more devices 140 to change based on the determined mobile devices near/proximate to the computing device for outputting content. The content may be sent to the computing device for outputting content, such as the media device 120 and/or the display device 121. For example, the content may be sent to the media device 120 and the media device 120 may prepare and/or forward the content 216 for display at the display device 121. For example, the content may also be sent to the one or more mobile devices associated with the determined profile via the network 116 or another network.

A selection of one or more of the recommended content items may be received at the computing device for outputting content, such as the media device 120 or the display device 121. The selected content item may be requested from and received from a content source 127 at the media device 120 and displayed on the display device 121. An indication of the requested content may also be sent by the media device 120 to the application server 126 via the network 116 or another network and added to the viewing history portion of the profile associated with the mobile devices near/proximate to the computing device for outputting content.

A request may be received to change one or more settings of the one or more devices 140, such as the thermostat 406, one or more receptacles 408, one or more switches 410, one or more luminaires 412a-d, a fan, a smart speaker 414, a security system, or the like. For example, the request may be received by the computing device for outputting content, such as the media device 120 and/or the display device 121, via a remote control device 404. For example, the request may be received via an application on one of the mobile devices 124a-b near/proximate to the computing device for outputting content. For example, the request to change one or more settings of one or more devices 140 may be sent from the computing device for outputting content to the access point 123. The access point 123 may be in wireless communication with the one or more devices 140 and may send the request to change the device setting to each particular device 140 in the request. For example, the request may include a request to change the temperature on a thermostat 406, to turn on/off one or more luminaires 412a-d (e.g., lights), to adjust the light level of one or more luminaires 412a-d, to change a setting on a fan, to change a volume of a smart speaker 414, to change a setting on a smart appliance, to change a setting on a security system for the location 119, to activate/deactivate one or more switches 410 or electrical receptacles 408 or change one or more other device settings on another device 140.

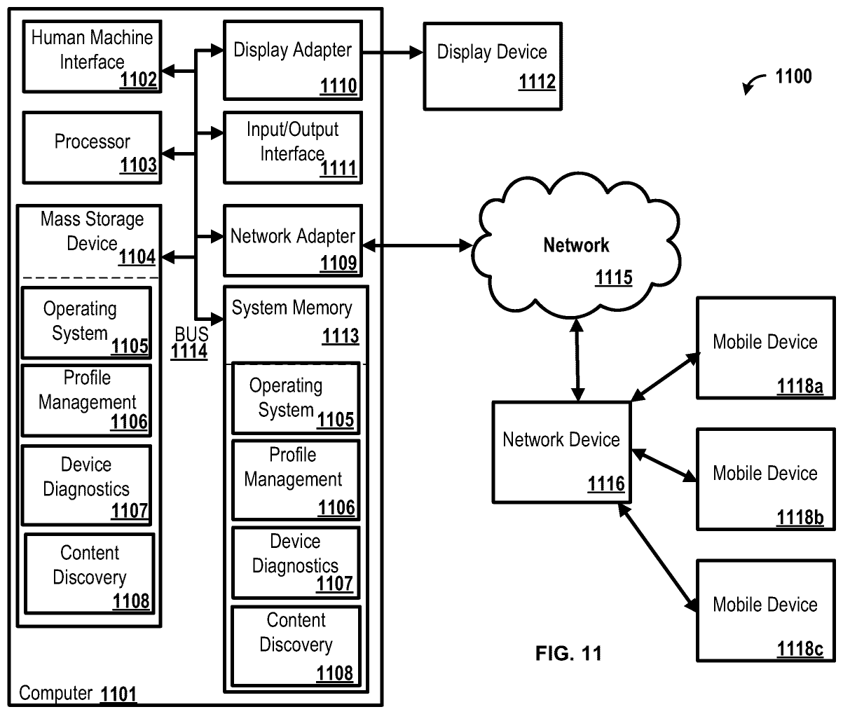

FIG. 11 shows a block diagram of an example system 1100 and computer 1101 for modifying audio content. Any device/component described herein (e.g., the central location 101, the application server 126, the computing device for outputting content, the media device 120, the display device 121, or the access point 123) may be the computer 1101 as shown in FIG. 11.

The computer 1101 may include one or more processors 1103, a system memory 1113, and a bus 1114 that couples various components of the computer 1101 including the one or more processors 1103 to the system memory 1113. In the case of multiple processors 1103, the computer 1101 may utilize parallel computing.

The bus 1114 may include one or more of several possible types of bus structures, such as a memory bus, memory controller, a peripheral bus, an accelerated graphics port, and a processor or local bus using any of a variety of bus architectures.

The computer 1101 may operate on and/or include a variety of computer-readable media (e.g., non-transitory). Computer-readable media may be any available media that is accessible by the computer 1101 and includes, non-transitory, volatile and/or non-volatile media, removable and non-removable media. The system memory 1113 has computer-readable media in the form of volatile memory, such as random access memory (RAM), and/or non-volatile memory, such as read-only memory (ROM). The system memory 1113 may store data such as profile management data 1106 and content discovery data 1108 and/or program modules such as an operating system 1105 and a device diagnostics engine 1107 that are accessible to and/or are operated on by the one or more processors 1103.

The computer 1101 may also include other removable/non-removable, volatile/non-volatile computer storage media. The mass storage device 1104 may provide non-volatile storage of computer code, computer-readable instructions, data structures, program modules, and other data for the computer 1101. The mass storage device 1104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1104. An operating system 1105 and a device diagnostics engine 1107 may be stored on the mass storage device 1104. Profile management data 1106 and content discovery data 1108 may also be stored on the mass storage device 1104. The profile management data 1106 and content discovery data 1108 may be stored in any of one or more databases known in the art. The databases may be centralized or distributed across multiple locations within the network 1115.

A user may enter commands and information into the computer 1101 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1103 via a human machine interface 1102 that is coupled to the bus 1114, but may be connected by other interface and bus structures, such as a parallel port, game port, an IEEE 1394 Port (also known as a Firewire port), a serial port, network adapter 1109, and/or a universal serial bus (USB).

A display device 1112 may also be connected to the bus 1114 via an interface, such as a display device adapter 1110. It is contemplated that the computer 1101 may have more than one display device adapter 1110 and the computer 1101 may have more than one display device 1112. A display device 1112 may be a monitor, an LCD (Liquid Crystal Display device), light-emitting diode (LED) display device, television, smart lens, smart glass, and/or a projector. In addition to the display device 1112, other output peripheral devices may comprise components such as speakers (not shown) and a printer (not shown) which may be connected to the computer 1101 via Input/Output Interface 1111. Any step and/or result of the methods may be output (or caused to be output) in any form to an output device. Such output may be any form of visual representation, including, but not limited to, textual, graphical, animation, audio, tactile, and the like. The display device 1112 and computer 1101 may be part of one device or separate devices.

The computer 1101 may operate in a networked environment using logical connections to one or more network computing devices 1116 and/or one or more mobile devices 1118a-c (e.g., mobile computing devices). The network computing device 1116 and/or one or more mobile devices 1118a-c may be a personal computer, computing station (e.g., workstation), portable computer (e.g., laptop, mobile phone, tablet device), smart television, set-top-box, smart device (e.g., smartphone, smartwatch, activity tracker, smart apparel, smart accessory), a server, a router, a network computer, a peer device, edge device or other common network nodes, and so on. Logical connections between the computer 1101 and a network computing device 1116 and/or one or more mobile devices 1118a-c may be made via a network 1115, such as a local area network (LAN) and/or a general wide area network (WAN). Such network connections may be through a network adapter 1109. A network adapter 1109 may be implemented in both wired and wireless environments. Such networking environments are conventional and commonplace in dwellings, offices, enterprise-wide computer networks, intranets, and the Internet.

Application programs and other executable program components such as the operating system 1105 and the device diagnostics engine 1107 are shown herein as discrete blocks, although it is recognized that such programs and components may reside at various times in different storage components of the computing device 1101, and are executed by the one or more processors 1103 of the computer 1101. An implementation of the device diagnostics engine 1107 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving a request associated with a computing device for outputting content;
determining, based on the request and based on one or more changes in at least one signal characteristic for at least one mobile device of a plurality of mobile devices, the plurality of mobile devices proximate to the computing device, wherein the plurality of mobile devices are associated with a plurality of persons;
determining, based on the plurality of mobile devices, one or more profiles associated with the plurality of persons; and
causing, based on the one or more profiles, an output of a content recommendation.

2. The method of claim 1, wherein the request associated with the computing device comprises one or more of a request to turn on a display device, a search request, a query, or a request for a content item.

3. The method of claim 1, wherein the plurality of persons comprises a first person and a second person, wherein the first person resides at a first residence and wherein the second person is a visitor to the first residence.

4. The method of claim 1, wherein determining the one or more profiles comprises:
determining an identifier for each mobile device of the plurality of mobile devices; and
determining, based on the identifier for each mobile device of the plurality of mobile devices, the one or more profiles.

5. The method of claim 1, further comprising:
receiving information associated with each of a plurality of devices connected to the network;
determining, based on the information associated with each of the plurality of devices connected to the network, the plurality of mobile devices located proximate to the computing device.

6. The method of claim 5, wherein the information comprises one or more of a signal-to-noise ratio, a quality of service, a signal strength, or an indicator of an antenna of a network device receiving a signal from the respective device of the plurality of devices.

7. The method of claim 1, wherein causing the output of the content recommendation comprises sending an indication of the content recommendation to one of a display device or a downstream computing device.

8. The method of claim 1, further comprising:
sending, to a network device, a request for information associated with devices connected to a network; and
receiving the information associated with each of a plurality of devices connected to the network, wherein the plurality of mobile devices proximate to the computing device is determined based on the information.

9. The method of claim 8, further comprising determining a first portion of the plurality of devices are stationary devices and determining a second portion of the plurality of devices are mobile devices.

10. The method of claim 1, further comprising:
determining, based on the plurality of mobile devices, that the profile associated with the plurality of mobile devices does not exist; and
generating the profile associated with the plurality of mobile devices.

11. The method of claim 1, further comprising causing, based on the profile associated with the plurality of mobile devices, an adjustment of a setting of a device.

12. A method comprising:
receiving a request associated with a computing device for outputting content;
determining a plurality of mobile devices proximate to the computing device, wherein the plurality of mobile devices are associated with a plurality of persons;
determining, based on the plurality of mobile devices, a first profile associated with a first person of the plurality of persons and a second profile associated with a second person of the plurality of persons; and
generating a profile for the first person and the second person, wherein the profile is associated with one or more content preferences indicated in the first profile and the second profile.

13. The method of claim 12, further comprising causing, based on the one or more content preferences associated with the profile for the first person and the second person, an output of a recommendation of content.

14. The method of claim 12, wherein the profile for the first person and the second person comprises content preferences in both the profile for the first person and the profile for the second person.

15. The method of claim 12, further comprising causing, based on the profile associated with the plurality of mobile devices, an adjustment of a setting of a device at the location of the computing device.

16. The method of claim 12, wherein determining the first profile comprises:
determining an identifier for a first mobile device of the plurality of mobile devices; and
determining, based on the identifier for the first mobile device of the plurality of mobile devices, the first profile.

17. The method of claim 12, further comprising:
receiving information associated with each of a plurality of devices connected to a network;
determining, based on the information associated with each of the plurality of devices connected to the network, the plurality of mobile devices located proximate to the computing device.

18. A method comprising:
determining a plurality of mobile devices within a premises, wherein the plurality of mobile devices are associated with a plurality of persons;
determining, based on the plurality of mobile devices, a profile associated with the plurality of persons;
determining a device setting for a device within the premises;
determining, based on the profile, a desired device setting for the device; and
causing, based on the profile, an adjustment of the device setting of the device to the desired device setting.

19. The method of claim 18, further comprising causing, based on the profile, an output of content at a display device.

20. The method of claim 18, wherein the device comprises one or more of a thermostat, a luminaire, a fan, a security alarm, a smart switch, or a smart device.

21. The method of claim 18, wherein causing the adjustment to the device setting of the device to the desired device setting comprises sending a signal to the device to change the device setting of the device to the desired device setting,
wherein the desired device setting comprises at least one of a desired temperature setting at a thermostat, a desired operational setting at an electrical receptacle, a desired operational setting at an electrical switch, a desired operational setting for a luminaire, a desired light output level for the luminaire, a desired operational setting for a fan, a desired speed level for the fan, a desired operational level for a smart speaker, a desired volume level for the smart speaker, or a desired operational level for a security system.
